(19) United States
(12) Patent Application Publication
(10) Pub. No.: US 2016/0285611 A1
(43) Pub. Date: Sep. 29, 2016

(54) RADIO WITH OOBE VICTIM DETECTION

(71) Applicant: CBF Networks, Inc., San Jose, CA (US)

(72) Inventors: Jeffrey Fischer, Boston, MA (US); Kevin J. Negus, Philipsburg, MT (US)

(21) Appl. No.: 15/050,009

(22) Filed: Feb. 22, 2016

Related U.S. Application Data
(63) Continuation-in-part of application No. 14/608,024, filed on Jan. 28, 2015, now Pat. No. 9,345,036.
Application No. 14/608,024 is a continuation of application No. 14/151,190, filed on Jan. 9, 2014, now Pat. No. 8,982,772.
Application No. 14/151,190 is a continuation-in-part of application No. 13/645,472, filed on Oct. 4, 2012, now Pat. No. 8,811,365.
Application No. 13/645,472 is a continuation of application No. 13/371,366, filed on Feb. 10, 2012, now Pat. No. 8,311,023.
Application No. 13/371,366 is a continuation of application No. 13/212,036, filed on Aug. 17, 2011, now Pat. No. 8,238,318.
(60) Provisional application No. 61/857,661, filed on Jul. 23, 2013.
(60) Provisional application No. 62/135,573, filed on Mar. 19, 2015.
(60) Provisional application No. 62/130,100, filed on Mar. 9, 2015.

(51) Int. Cl. H04L 5/00; H04W 72/04; H04W 72/08

(52) U.S. Cl. CPC H04L 5/0062; H04W 72/082; H04W 72/0453; H04W 72/046; H04W 72/048

(57) ABSTRACT

A radar detector is used with a radio link, the radio link characterized by high duty factor operation of a radio transmitter. The radar detector is located a sufficient distance from the radio transmitter that the radar detector is not overwhelmed by the radio transmission signal in that channel and can detect sufficiently low level radar signals to ascertain potential radio interference at the radar from said radio transmitter. The results of the radar detection are communicated to the transmitter in a way that impacts the transmitter's use of the sensed channel. This communication can occur reactively when a radar detection is achieved (the absence of which indicates no radar has been detected) and/or can be a periodic or event-driven indication that the channel is available for operation (the information expiring if the result is not refreshed). A highly sensitive radar detector apparatus that can detect wideband radar signals at very low levels and overcome the disparity of detection range versus interference range is described. A signal detector is also described that detects energy from other users that is not in the operating channel or operating band of the transmitter to determine if the out of band emissions or out of channel emissions of the operating transmitter's signal need to be adjusted through such settings as transmit power, operating channel, filtering, or a combination.

### CROSS-REFERENCE TO RELATED APPLICATIONS

The present application is a continuation-in-part application of U.S. patent application Ser. No. 14/608,024, filed Jan. 28, 2015, which is a continuation application of U.S. patent application Ser. No. 14/151,190, filed Jan. 9, 2014 (now U.S. Pat. No. 8,982,772), which claims priority to U.S. Patent Application No. 61/857,661, filed Jul. 23, 2013 and which is a continuation-in-part of U.S. patent application Ser. No. 13/645,472, filed Oct. 4, 2012 (now U.S. Pat. No. 8,811,365), which is a continuation application of U.S. patent application Ser. No. 13/371,366 filed Feb. 10, 2012 (now U.S. Pat. No. 8,311,023), which is a continuation application of U.S. patent application Ser. No. 13/212,036 filed Aug. 17, 2011 (now U.S. Pat. No. 8,238,318), the disclosures of which are incorporated herein by reference in their entireties.

The present application also claims priority to U.S. Provisional Patent Application Ser. No. 62/130,100, filed Mar. 9, 2015 and U.S. Provisional Patent Application Ser. No. 62/135,573, filed Mar. 19, 2015, the disclosures of which are incorporated herein by reference in their entireties.

The present application is also related to U.S. patent application Ser. No. 13/536,927, filed Jun. 28, 2012 (now U.S. Pat. No. 8,467,363), U.S. patent application Ser. No. 13/898,429, filed May 20, 2013 (now U.S. Pat. No. 8,824,442), U.S. patent application Ser. No. 14/336,958, filed Jul. 21, 2014 (now U.S. Pat. No. 9,001,809), U.S. patent application Ser. No. 14/632,624, filed Feb. 26, 2015 (now U.S. Pat. No. 9,178,558), U.S. patent application Ser. No. 14/837,797, filed Aug. 26, 2015, U.S. patent application Ser. No. 14/197,158, filed Mar. 4, 2014 (now U.S. Pat. No. 8,928,542), U.S. patent application Ser. No. 14/199,734, filed Mar. 6, 2014 (now U.S. Pat. No. 8,872,715), U.S. patent application Ser. No. 14/559,859, filed Dec. 3, 2014, U.S. patent application Ser. No. 14/337,744, filed Jul. 22, 2014 (now U.S. Pat. No. 9,055,463), U.S. Provisional Patent Application Ser. No. 61/910,194, filed Nov. 29, 2013, U.S. patent application Ser. No. 14/498,959, filed Sep. 26, 2014 (now U.S. Pat. No. 9,049,611), U.S. patent application Ser. No. 14/688,550, filed Apr. 16, 2015, U.S. patent application Ser. No. 14/686,674, filed Apr. 14, 2015, U.S. patent application Ser. No. 14/988,578, filed Jan. 5, 2016, U.S. patent application Ser. No. 13/609,156, filed Sep. 10, 2012 (now U.S. Pat. No. 8,422,540), U.S. patent application Ser. No. 13/767,796, filed Feb. 14, 2013 (now U.S. Pat. No. 8,638,839), U.S. patent application Ser. No. 14/108,200, filed Dec. 16, 2013 (now U.S. Pat. No. 8,948,235), U.S. patent application Ser. No. 14/572,725, filed Dec. 16, 2014, U.S. patent application Ser. No. 13/763,530, filed Feb. 8, 2013 (now U.S. Pat. No. 8,649,418), U.S. patent application Ser. No. 14/146,891, filed Jan. 3, 2014 (now U.S. Pat. No. 8,897,340), U.S. patent application Ser. No. 14/535,972, filed Nov. 7, 2014 (now U.S. Pat. No. 9,252,857), and U.S. patent application Ser. No. 14/983,059, filed Dec. 29, 2015, the disclosures of which are hereby incorporated herein by reference in their entireties.

### BACKGROUND

1. Field

The present disclosure relates generally to data networking and in particular to detection of radars and other potential victims of radio transceivers used for connecting remote edge access networks to core networks.

2. Related Art

Connections to remote edge access networks from core networks are often achieved with wireless radio, wireless infrared, and/or copper wireline technologies. Radio, especially in the form of cellular or wireless local area network (WLAN) technologies, is particularly advantageous for supporting mobility of data networking devices. However, cellular base stations or WLAN access points inevitably become very high data bandwidth demand points that require continuous connectivity to an optical fiber core network. When data aggregation points, such as cellular base station sites, WLAN access points, or other local area network (LAN) gateways, cannot be directly connected to a core optical fiber network, then an alternative connection, using, for example, wireless radio or copper wireline technologies, must be used. Such connections are commonly referred to as “backhaul.” The array of network backhaul and other high throughput radio applications include point-to-point, point-to-multipoint, networks of multiple point-to-point and multipoint links, ad hoc, ring, self-organizing and mesh networks. These network architectures, often using directive antennas, are needed to support wireless last mile hops and wireless backhaul applications that are used to bring high throughput services to cellular telephone systems and broadband services to enterprises and the home.

Increasingly, high throughput services to consumers and business are becoming one of the cornerstones of future economic vitality. It is very efficient to support these high-demand needs using frame-based transmission links, and particularly so with very high duty factor transmission frequency domain duplexing (FDD). A frame-based system refers to radios with continuous or near-continuous time transmission where time is divided into frames. Each frame carries channel estimation and control information, as well as multiple opportunities to stuff incoming packet-based data onto the frame. When there is no network data available, the frame is transmitted with dummy data blocks. This allows the dropping of incoming data into the data blocks with very low latency and high reliability. The low latency comes from the fact that the link is already running and just needs to substitute the incoming data for the dummy data. The high reliability comes from the fact that the link can be set up and maintained over a period of time that is longer than what would be efficient in a packet radio link. This view of frame-based operation is consistent with the definition of “frame based” in the European ETSI standard EN 301 893.

Radio signals can interfere with radar reception. Because the protection of radar operation is important, regulatory bodies control channel access of radio systems that share the band with radars and set up radar signal level limits for detection of various types of radar signals. In many regulatory regions, a transmitted radar signal that is detected by a radio's radar detector at −64 dBm is considered too close to the radio system and the radio system must cease transmitting on that channel and move to another channel. A channel is the occupied bandwidth of the data transmission stream over the RF link. But a channel may comprise more than one noncontiguous part where each part can have a different center frequency and occupied bandwidth. The channel frequency of each part is its center frequency.

Although effective for high performance communications, FDD frame-based radio operation makes detection of radar signals using conventional methods impossible. In effect, frame-based transmission is similar to circuit switched operation of the older telephone circuit switching technology. In an FDD link, frame based transmitters can operate at up to 100% transmit duty factor because the responses for each channel arrive in the other channel—a single transceiver can operate with up to 100% transmit duty factor in one channel and up to 100% receive duty factor in another channel, while the transceiver on the other end of the communication link does the opposite on the channels. Various implementations may use less than 100% duty factor to, for example, sense the channel to satisfy a channel sharing regulation or system wide self-interference requirements. But, in each case, the duty factor is significantly higher than a packet radio system and can approach 100% in many cases. Thus, with typical FDD radios, the transmitters on both ends of an FDD link usually transmit together coincident in time for at least some fraction of every frame. When the transmit duty factor is high, this means that radar detection for one or both of the transmit directions is preferably performed within a fraction of every frame that includes this fraction where both ends of an FDD link transmit together coincident in time.

In bands that require radar detection, there is typically a sequence of stages that a transmitter goes through before and at the beginning of operation. In the first stage, prior to operation, the transmitter determines whether the channel is clear of radar transmissions. The regulatory agencies call this stage Channel Availability Check (CAC). In CAC, the radar detector informs the transmitter that a channel cannot be used if certain types of radar are detected. If such radars are detected, the channel is typically off limits for 30 minutes, at which time another CAC must be performed. The next stage is link operation. In the link operation stage, the receiver detects and acquires the transmission and a round trip connection is made (for full duplex). Often, the receiver and transmitter negotiate an operating frequency. During this period of time, which may be part of a radio channel “bootstrap” sequence, radar monitoring may continue. Typically, there is a 200 ms regulatory requirement for a transmitter to stop transmitting after a radar pulse sequence occurs on a channel. If the bootstrap sequence is a significant duration on the scale of 200 ms, then, under most regulatory requirements, radar monitoring is still needed. After the bootstrap sequence, normal run-mode operation can occur. During this time, in-service monitoring for the radar occurs. The in-service monitoring requires the detection of the presence of certain types of radar on an operating channel and closing the transmission within 200 ms (i.e. the required close time) of the end of the radar pulse train that is used to certify this operation in testing. It should be noted that over the course of a radio's operating time, it may re-enter the bootstrap mode and the normal run-mode operation multiple times, particularly if the synchronization between the radios is disrupted, or even as a normal maintenance operation.

One problem with existing networks is that when the transmitter is transmitting, the high signal level swamps out the receive signals for typical receivers that are located in close proximity to the transmitter, thereby limiting the ability for a radar detector co-located with the transmitter to detect a radar signal.

Packet radio systems, such as WiFi, handle this by testing their radar detection operation while transmitting at low duty factor, typically much less than 40% transmission period. These packet radio systems detect the radar with a co-located detector at the transmitter while the transmitter is not sending and the radio is available to receive or is receiving. The channel monitoring applies to the next time the transmitter operates. If a WiFi system operates with a transmit traffic load such that it uses a high duty factor, it can miss radar detections.

US20070264935 to Behzad Mohebbi, assigned to Nextivity, describes a bi-direction FDD link for use in the 5 GHz USA UNII-2 band, which requires radar detection. Because the Mohebbi disclosure is bi-directional in nature, it first transmits FDD in one direction on frequency channel 1, while receiving on frequency channel 2, then switches so that the same radio that was transmitting on channel 1 now transmits FDD on channel 2 and receives on frequency channel 1. Although the radar detector for the local transmitter is co-located with the transmitter, the detection is performed on the transmitter channel during the half cycle period that the transceiver is receiving on that channel for the forthcoming transmission. In this way, the Mohebbi disclosure is closely related to WiFi, which performs radar detection when in receive mode for forthcoming transmissions; Mohebbi differs in that it is not performing radar detection for the transmitter that is operating on the other end of the link. Mohebbi is more accurately described as a pair of TDD links, each on one frequency, which have anti-phase transmit/receive cycles. In other words, there is a TDD transmission between radios on channel 1 and another on channel 2, but at each transceiver, it transmits on channel 1 while receiving on channel 2 and vice versa. In Mohebbi, each transceiver transmits a first portion to the other on a frequency 1, while receiving from the other on frequency 2, and radar detecting on a frequency 2; and, each transceiver transmits a second portion to the other on the frequency 2, while receiving from the other on the frequency 1, and radar detecting on frequency 1. Therefore, each transceiver in Mohebbi performs radar detection on both frequency 1 and frequency 2 during the receive period for that frequency to enable the transmission on that frequency on the opposite TDD cycle, similar to the way a WiFi packet radio radar detector operates. It cannot perform radar detection on the transmit channel while the transmitter is transmitting. The Mohebbi system is also inferior in radio performance because it requires a clear channel available in both directions for two frequencies, which is very difficult to achieve from a frequency planning point of view. Additionally, the UNII-2 band is a commonly used unlicensed band that has no controls on interference. The best performance occurs in channels that show the lowest interference levels; interference is a receiver phenomenon. The level of interference measured at the transmitter is uncorrelated to that measured at the receiver simply because there is different propagation from an arbitrarily placed interference source to each side. It is only the interference level at the receiver and not the transmitter that matters because that is what causes reduced signal to interference levels. If a transceiver must receive at two frequencies to maintain a link, it must find two channels that are relatively free of interference to operate, making it much harder to create a good link; in a probabilistic interference setting, this requirement, at a minimum, squares the difficulty of operation. Moreover, in the system of Mohebbi these two channels must be clear at both transceivers on either end of the link and for backhaul radios separated by considerable distances this also squares the difficulty of operation because the interference environments at each end of the link are likely quite different. Also, since the receiving period is the time when the radar detection for the transmitter must be performed in Mohebbi, the transmit and receive channels for one of the pair of “first and second portions” must be the same. That is why it is effectively a pair of TDD channels.

In a WiFi application, the transmissions are packetized and the transmitters generally operate at a low duty factor. In fact, when the transmitters are tested for regulatory compliance for radar detection, they operate at less than a 40% duty factor. Packet radio systems are able to detect radars with the radar detector co-located with the transmitter because they detect the radar signals during the typically greater-than-60% of the time the transmitter is not transmitting.

Thus, the frame-based FDD system has particular challenges for performing radar detection under the various regulatory requirements around the world because, unlike packet-based transmitters such as WiFi radios that can operate at a modest duty factor, the frame-based transmitter is active at high duty factors. There is no opportunity for performing in-service monitoring local to the transmitter under the conventional art because the detection mechanism must listen for signals at −64 dBm while the transmitter is operating on the same channel at, for example, +30 dBm or higher and at nearly 100% duty factor.

By most regulations, a channel which requires radar detection cannot be occupied before completing a 60 second listen period for radars (CAC). If a radio transceiver is forced to vacate its operating channel and it does not have another channel queued up that it has already performed a successful CAC on, it will have to remain off the air for at least 60 seconds. An outage of this length is unacceptable in many applications.

Also, it is often a regulatory requirement that when a radar is detected in a channel, at least 80% of the occupied bandwidth of the channel must be vacated and must remain unused by the detecting system for at least 30 minutes, despite the actual receiver operating bandwidth of the radar. But for wideband devices, as are often found in high-duty-factor links that achieve high throughput, this unduly punishes a system for spreading its channel power over a wider bandwidth, thus reducing its spectral power density.

Radars often have very high gain antennas. They also are subject to interference at a much lower signal level than the level at which it is possible for a detector to reliably sense the presence of the radar signal. This asymmetry is partially offset by the large radiated power of the radar compared to that of typical radio systems, but the detector is still disadvantaged. As a result, those radars may be interfered with by a radio signal at a much greater distance than a detector co-located with the radio is able to detect the presence of the radar signal. The asymmetry of the antenna gain is related to the requirement for radar detector needing to look over a wide angle, in many cases all angles simultaneously, while the radar can use a “pencil” beam.

The asymmetry is readily illustrated in the simplified link calculations of Table 1 based on exemplary assumptions (a blank box means the entry is not applicable):

TABLE 1

| | | | Example |
|---|---|---|---|
| | Example | Example | Prior Art |
| | Radar | Radio | Detector |
| Tx power into antenna | 100 W | 100 mW | |
| Antenna Gain (Tx and Rx) | 40 | 2 | 2 |
| (dBi) | | | |
| Radar Noise Floor at LNA | −110 | | |
| In 1 MHz BW plus noise figure | | | |
| (dBm) | | | |
| Level at which interference raises | −118 | | |
| Radar noise floor by .6 dB (dBm) | | | |
| EIRP (dBm) | 90 | 22 | |
| Free Space Path Loss at 1 meter | 47 | 47 | 47 |
| and 5.5 GHz (dB) | | | |
| Line of Sight Range between | 100 | 100 | 100 |
| Radio/Detector and Radar (Km) | | | |
| Free space propagation loss | 100 | 100 | 100 |
| between Radio/Detector and Radar | | | |
| (dB) | | | |
| Clutter Loss between | 10 | 10 | 10 |
| Radio/Detector and Radar (dB) | | | |
| Total Path Loss between | 157 | 157 | 157 |
| Radio/Detector and Radar (dB) | | | |
| Receive level from Radio (dBm): | −95 | | |
| Receive level from Radar (dBm): | | | −65 |
| Detection Threshold (dBm) | | | −64 |

The exemplary scenario shown in Table 1 is used to illustrate the utility of the invention in one case, and it is recognized there are many other cases for which the invention implies. In this exemplary scenario, the radio and radar detector are co-located and are at 100 km distance from the radar. The radar signal received at the detector, in this example, is given by:

Received radar signal at detector=Radar EIRP−Total Path Loss+Detector antenna gain=−65 dBm

This value is just below the detection threshold of −64 dBm.

At the same time, and at the same 100 km range, the level from the radio received at the radar is given by:

Received radio signal at the radar=Radio EIRP−Total Path Loss+Radar antenna gain=−95 dBm

This value is 23 dB higher than the level at which the radio would interfere with the radar. Even though the radar has nearly a 70 dB higher EIRP than the radio, the combination of the 38 dB difference in the receive antenna gain and the 53 dB lower level that affects radar sensitivity compared to that at which the detector can operate, overwhelm the EIRP difference.

It this example, the radar receives an interfering signal from the radio 23 dB above its required limit at the same distance that the radar signal is just below being able to be detected by the detector. Thus the radio interferes with the radar because it cannot reliably determine that the radar is within its interference range. If the detector were able to detect the radar, it would inform the radio to stop transmitting on that channel and the interference would not occur.

The detection threshold number of −64 dBm cannot be easily lowered while maintaining accurate detection of the radar pulses. The radar detection requires a high probability of detection and low probability of false detection of RF pulses with unknown phase and with only broadly constrained parameters, while receiving in the high interference levels of an unlicensed RF spectrum. Radar signals can vary from less than 1 microsecond (there is current speculation that pulses of duration 0.1 microseconds will need to be detected) to as wide as 100 microsecond pulses and with pulse repetition intervals that range from sub-millisecond to several milliseconds. These also include waveforms that frequency hop and chirp. Detections are normally performed with a combination of edge filtering and feature detection.

Typically, reliable RF pulse detection with highly constrained parameters requires at least 20 dB SNR (Radar Detection, J. V. DiFranco, W. L. Rubin, Prentice-Hall, 1968). In order to pass a pulse of 0.1 usec, at least 20-30 MHz of bandwidth is required for the pulse to reach full amplitude. That bandwidth, and a reasonable noise figure, can result in a noise floor of about −96 dBm. That noise level and a 20 dB SNR would limit the detection of the radar to −76 dBm in thermal noise, using an ideal matched filter detector, and without interference present. While this theoretical limit is an improvement over the threshold of −64 dBm, it is still not low enough to prevent interruption of service to the radar (consider the exemplary scenario in Table 1). In actuality, because it is not practical to match filter to the wide variety of radar pulse characteristics, a much higher SNR is required than the matched filter limit. Experience shows that even a radar level of −64 dBm can often lack the desired reliability for detecting all the types of radars that one is required to detect. Lowering the detection threshold of the radar detector makes it more susceptible to false detections. False detections can be very costly because there are regulations that require that upon getting a radar detection, the instant channel in which the radar is detected shall be blocked for 30 minutes.

To compensate for this asymmetry in detectability vs interference, a radar detector could also be made with high antenna gain. However, it would not be fully effective because the associated directionality of the antenna that accompanies the high gain needed would prevent the detector from seeing in all directions of importance (there may be some limits on the angle of arrival requirements in a particular situation). The detector antenna would have to be pointed at the radar, but since there can be no prior knowledge of where the radar is or the angle of arrival of its signal relative to the detector, this is not, in general, practical.

When a radio signal is generated and radiated (also known as being emitted) the frequency range where most of the signal energy lies is considered the operating channel. The operating channel lies generally within a range of operating channels that are made available for use by a regulatory agency (e.g. the FCC) for the type of equipment that is doing the radiating. This range of available channels that can be used is referred to as the operating band. The channels do not have to be prescribed as specific center frequencies and bandwidths, although in some situations that is the case. There will usually be some restriction on either the total RF power and/or the power spectral density emitted in the allowed operating band. The power spectral density is the amount of power that is radiated within a specified bandwidth (e.g. 1 MHz). An example of a power spectral density limit is 11 dBm/MHz. If a 10 MHz wide signal is transmitted at this power spectral density, it would be emitting a total power of 21 dBm. This calculation is made by multiplying the limit by the bandwidth.

It is not possible to create a transmitted signal that is perfectly truncated at the bandwidth of its operating channel as there is always some energy lying outside the channel. In fact, Fourier transform theory tells us that in order for the signal energy to be 100% limited in bandwidth, it would have to be infinite in time. Conversely, because signals are certainly truncated in time by logic that turns signals on and off or makes changes in their amplitude or phase, they have frequency spectral energy (frequency sidelobes) that extend to infinity on both sides of the operating channel; albeit at generally decreasing levels as you get further away from that channel.

The transition band is the region of spectrum from the edge of the main part of the channel to where some arbitrary specification of reduced energy level is achieved. Different modulation methods result in different rates of transition. The size of the transition bandwidth, also known as the transition region, and also referred to regarding its transition rate or the roll-off, depends on the type of modulation used; whether the modulation is real or complex (from the point of view of the baseband signal phases), whether the modulation is simple symbols or spread spectrum (i.e. time bandwidth greater than 1), whether the modulation is single carrier or multi-carrier, etc. Some standards and some regulations place a specification on the slowest allowed transition rate in the form of a transmit mask.

The useable radio spectrum is divided up among different radio services so that different markets can be served. For example, FM radio in the US operates in the 88-108 MHz band, although each of the channels is 200 KHz wide. Wi-Fi in the US operates in the 2.4 GHz-2.4835 GHz band and in four bands in the 5 GHz range called U-NII-1 to U-NII-4, which ranges from 5.15 GHz-5.925 GHz. These are unlicensed bands. But there are other radio services, some with higher priority, which can operate in the same bands, or in adjacent bands. There are already methods for sharing and prioritizing when services have to coexist in the same band on the same channel. The instant invention addresses operation in adjacent bands. Sometimes the words alternate band are used to describe a band that is nearby the operating band, but not contiguous with it. In this discussion and claim language, the inventors specifically will include alternate bands as part of the meaning of adjacent bands.

To prevent RF energy that appears in the frequency sidelobe of a signal operating in a channel in one frequency band from interfering with receiver equipment operating in frequency bands that are adjacent (or nearby in an alternate band), regulatory agencies or standards bodies create restrictions on out of band emissions (OOBE). OOBE is a specification on the amount of RF emissions that are allowed outside of the operating band when transmitting. OOBE is usually specified as either a relative number, where it would be a reduction in level from the in-band transmission, or an absolute level, where it would often be specified as a maximum power spectral density. The OOBE specification for one operating band is intended to keep the adjacent and nearby bands clean of RF energy splatter for users operating in those bands.

The energy that extends beyond the transmit channel can be controlled with a combination of pulse shaping and filtering. Pulse shaping is also a form of filtering but with a specific time domain response, and is considered part of the natural roll-off of the signal. If the modulation pulses were square, then the first frequency sidelobe would be only 13 dB down from the mainlobe, and the remaining frequency sidelobes would roll off slowly. Pulse shaping, for example root raised cosine or Hamming window filtering, can make these natural sidelobes fall off much faster.

In many cases the OOBE limits are so extreme that this combination of techniques either cannot get low enough due to system spurious, or have to be used so extensively as to make it prohibitively expensive or impractical to use in-band operation that fully exercises the parameters allowed by the in-band regulations. Even if extensive digital and analog filtering is used, a very small amount of spectral regrowth or spurious can impact passing the extreme filtering requirements that regulations impose. In this case, the radio power must be turned down in the operating channel, or the channels near the edge of the band cannot be used, or a combination of both, in order to keep the OOBE under the regulatory limits.

As an example of how difficult this problem is, consider operation in the FCC regulatory band called U-NII-1 (Code of Federal Regulations 15.407), which is the 100 MHz band from 5.15 GHz-5.25 GHz. This band has two OOBE specifications that have to be met; the part 15.407 specification and the part 15.209 specification. The part 15.407 OOBE specification is a peak power level of −27 dBm/MHz effective radiated power with respect to isotropic (EIRP). This measurement refers to the radiated signal level which, for constant power into the antenna, increases with an increase in antenna gain; subsequently making the filtering problem worse. In this band, the 15.407 regulations say that point to point operation is allowed with up to 23 dBi antenna gain, and a power spectral density of 17 dBm/MHz, or a maximum of 1 W into the antenna. (For a channel bandwidth of 20 MHz, the 17 dBm/MHz power spectral density computes to 1 W also, or 30 dBm.) The 17 dBm/MHz is an average power level. The −27 dBm/MHz OOBE is a peak level. Assuming a peak to average power level of 10 dB, and including the antenna gain, the amount of suppression of the OOBE signal below that transmitted in the channel is calculated by subtracting the OOBE from the EIRP (including antenna gain) as follows, using the power spectral density of the signal because that is how the OOBE is specified:

Suppression=23 dB+17 dBm−(−27 dBm−10 dB)=77 dB

The second specification (part 15.209) is the restricted band specification below 5.15 GHz, which equals approximately −41 dBm/MHz average power spectral density. The amount of suppression of the signal spectrum that is needed is calculated as follows:

Suppression=23 dB+17 dBm−(−41 dB)=81 dB

Clearly the later specification is the more restrictive of the two in this example.

Another way to represent the amount of filtering is in dBc, which is dB relative to the carrier channel. For a flat spectrum, the number would the same as the numbers calculated based on power spectral density.

As another example, consider an outdoor Wi-Fi access point operating in this band. The transmit power may be 1 Watt or 17 dBm/MHz into the antenna, with an antenna gain of 6 dBi. The amount of part 15.209 suppression of the OOBE signal spectrum from the operating channel spectrum that is needed is calculated as follows:

Suppression=6 dB+17 dBm−(−41 dB)=64 dB

The 64 dB or 81 dB of suppression calculated above for different types of equipment is obtained through a combination of the natural roll-off of the unshaped signal, the pulse shaping, and the frequency-specified filtering of the frequency sidelobes. The filtering can be performed using a combination of digital and analog filtering at baseband, IF filtering if an IF stage is included, and some RF filtering at the RF frequencies. But the RF-frequency filtering that can be achieved in a very narrow transition band without also cutting into the desired signal is very limited. The only solution available in the prior art is to just not operate the channel at full power near the band edge of 5.15 GHz, and to heavily filter the channel by cutting into the main part of the spectrum. The region where channels are not used so that the spectrum can transition is often referred to as a guard band. In fact, the filtering calculated above requires a guard band that is a significant portion of the entire available band in order to provide sufficient transition to 81 dB of suppression. Therefore, much of this 100 MHz band essentially becomes unusable at this power level. Even at lower power levels, it is very difficult to make use of more than half the band. Typical suppression that can be achieved even in modestly priced radio equipment is between 50 and 60 dB. Even if the filtering at baseband exceeds this value, by the time the signal is modulated and reaches the antenna, the up-conversion spurious and spectral regrowth reduces the effect of the baseband filtering. Designs often require substantial power amplifier back-off to reduce the spectral regrowth and spurious modulation, yet experience teaches us that there is still not enough suppression to utilize the major part of the band at the full allotment of EIRP.

The OOBE signals impact the receive sensitivity of equipment operating in the adjacent bands. The impacted equipment is often referred to as the victim equipment, and the equipment that is doing the emitting is the impinging equipment (or the operating transmitter).

The distance that the OOBE impact will create a problem can be computed from the Friis range equation. For example, an emitted peak power spectral density of −27 dBm/MHz (with a peak to average of 10 dB) at 5.15 GHz, assuming free-space propagation and a 47 dB free-space path loss (fspl) at 1 meter, is at a received power of 8 dB below the sensitivity level of a device with a receive bandwidth of 1 MHz, receive sensitivity of −110 dBm, and receive antenna gain of 40 dBi, at a range R, where R is calculated as:

R=10̂(−27−10−47−(−110−40−10))/20=6.3 km

An OOBE level that is 20 dB higher than the 15.407 regulation (i.e. −7 dBm/MHz peak) would influence the sensitivity of the receiver at 63 km line of sight free space propagation.

Note that this calculation assumes a very large antenna, for example, such as a large stationary airport radar. Smaller antennas shrink the value of R. An antenna of just 20 dBi reduces the value of R by a factor of 10, so that an OOBE level of −27 dBm/MHz peak only influences the sensitivity of an OOBE receiver at a range of 0.63 km.

Many times adjacent-band victim equipment that is protected by regulations is so sparsely deployed that a 6.3 km radius around all the equipment using the band would not occupy a significant total area of, for example, the United States. It would seem to be easy to simply adjust the requirements on OOBE based on location of the in-band radiator, however, it is often not known beforehand where either the in-band radiator or the out-of-band receiver is located. Another calculation that can be done is to assume absolute worst case conditions of the 40 dBi dish antenna, and that it is rotating, and all views it has of equipment with radiation level are excited by signals with OOBE energy in its band at the legal limit, and that there are 50 such pieces of equipment simultaneously operating in the lower 48 states.

The area of a circle with radius 6.3 km=125 sq km.

The amount of the lower 48 states that are affected is 50*125 sq km/8e6 sq km=8e-4, or 0.08%.

That is, 99.92% of locations in the 48 states are getting protection from a non-existent problem.

If the OOBE regulation level is raised by 20 dB to −7 dBm/MHz, the affected area is 12,500 sq km, and equipment located in 92% of the area in the 48 states is still forced to provide regulatory protection for a non-existent problem.

Still, with all this overprotection, if the operating transmitter is less than 6.3 km away from the victim, the victim's receiver will be affected. The pre-selection of this level both creates an unnecessary burden for the operating transmitter and only partly solves the victim's problem.

For a more modest case of lower receive antenna gain on the equipment that is being protected, the wasted protection is even higher. Furthermore, the protected equipment is not operating all the time and the in-band emitter that is creating the OOBE isn't operating all the time. When incorporating operating percentages, the amount of wasted protection adds up to a very high percentage.

The wasted protection really equates to wasted spectrum. If the OOBE can be raised, more in-band spectrum can be utilized at a higher power and with higher performance.

However, for many types of equipment, there is no way to know a priori where the protected equipment is located or when it will be operating.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Some embodiments of the claimed invention are directed to point-to-point links, a point-to-two-point link, general point-to-multipoint, networks of multiple point-to-point and multipoint links, ad hoc, self-organizing and mesh networks in which a radar detector is co-located with the receiver of the transmission in the channel on which it is detecting. This approach can outperform a radar detector that is co-located at the transmitter.

In an additional exemplary embodiment, a higher degree of directionality for the transmit signal antenna than for the radar detection antenna is used, which biases the detection operation in favor of the radar detector so that the radar will be detected at the receiver at a greater range than it will be interfered with by the radio transmitter. In an additional exemplary embodiment, the radio link uses a directional antenna for the radio link transmitter and an omnidirectional antenna or antenna that is omnidirectional in azimuth is used for the radar detector and it is taught that other combinations work well also.

Embodiments of the invention are applicable to both frequency division duplex (FDD) operation and time division duplex (TDD) operation of the radio link. Performance can be improved with an FDD link using a radar detector co-located with the receiver on the channel on which it is detecting, because the detector can listen for the radar with 100% duty factor. This high-duty factor availability of the radar detector creates a peak-detection capability over time that insures the detector is exposed to the largest radar signal of the time varying channel, mitigating the losses from multipath fading due to channel variations and a rotating radar detection antenna.

According to an aspect of the invention, a wireless communications system is disclosed that includes a first transceiver, wherein the first transceiver includes a first transmitter, a first receiver, and a first radar detector, and wherein the first transmitter transmits on a first transmit channel; a second transceiver, wherein the second transceiver includes a second transmitter and a second receiver, and wherein the second transmitter transmits on a second transmit channel; wherein the first receiver receives from the second transmitter on the second transmit channel and the second receiver receives from the first transmitter on the first transmit channel; wherein the first transmit channel is within a first transmit frequency band and the second transmit channel is within a second transmit frequency band; wherein the first radar detector is configured to detect radars within a first radar detection frequency range that includes at least part of the second transmit frequency band; wherein the first radar detector is configured to detect radars within at least a first time period, the first time period comprising at least a period of time when the first transmitter and the second transmitter both transmit coincident in time; wherein the first radar detector communicates at least a first radar detection result via the first transmitter to the second receiver; and wherein the first radar detection result is an input to a controller associated with the second transmitter.

The first radar detector may be configured to be not transmit-impaired by the second transmitter when the second transmitter transmits, at least in part due to a physical separation of the first radar detector and the second transmitter.

The first radar detector may be configured to be not transmit-impaired by the first transmitter when the first transmitter transmits, at least in part due to a physical separation of the first radar detector and the first transmitter.

The first radar detector may be configured to be not transmit-impaired by the first transmitter when the first transmitter transmits, at least in part due to an the antenna pattern of the first radar detector relative to the antenna pattern of the first transmitter.

The controller associated with the second transmitter may cause the second transmitter to adjust at least one adjustable parameter associated with the second transmit channel.

The at least one adjustable parameter associated with the second transmit channel may be a transmit power of the second transmitter.

The at least one adjustable parameter associated with the second transmit channel may be a center frequency or a channel bandwidth.

The transmit power of the second transmitter after an adjustment may be at a level below that of a regulatory limit for transmit power within a channel for which a radar has been detected.

The first radar detection frequency range may be at least 80% of the bandwidth of the second transmit channel.

The first radar detection frequency range may further include at least 80% of the bandwidth of an alternate channel that is different from the second transmit channel.

The first radar detection result may be communicated within a radar detection message, control frame or status that at least indicates whether or not at least one radar has been detected within the first radar detection frequency range.

The first radar detection result may be communicated within a radar detection message, control frame or status that at least indicates whether or not at least one radar has been detected within the second transmit channel.

The radar detection message, control frame or status may indicate at least one or both of the bandwidth or center frequency of the at least one detected radar within the first radar detection frequency range.

The part of the first time period when at least the first transmitter and the second transmitter both transmit coincident in time may be 100% of the first time period for which the first radar detector is configured to at least detect radars.

The controller associated with the second transmitter may cause an adjustment or a non-adjustment of at least one adjustable parameter associated with the second transmit channel depending on the first radar detection result.

The first transmit frequency band may overlap in frequency with the second transmit frequency band. The first radar detection frequency range may not overlap in frequency with the first transmit frequency band.

The first radar detection frequency range may be identical to or a subset of the second transmit frequency band.

The wireless communications system may further include a second radar detector; wherein the second radar detector is configured to detect radars within at least a second time period, the second time period including at least a period of time when the first transmitter and the second transmitter both transmit coincident in time; wherein the second radar detector is configured to detect radars within a second radar detection frequency range.

The first time period may overlap in time with the second time period.

The second radar detection frequency range may exclude the second transmit channel.

The second radar detection frequency range may include at least an alternate channel that is different from the second transmit channel.

The second radar detector may be within the first transceiver; wherein the second radar detector communicates at least a second radar detection result via the first transmitter to the second receiver; and wherein the second radar detection result is an input to the controller associated with the second transmitter.

The second radar detection result may be communicated within a radar detection message, control frame or status that at least indicates whether or not at least one radar has been detected within an alternate channel.

The second radar detector may be within the second transceiver; wherein the second radar detector communicates at least a second radar detection result via the second transmitter to the first receiver; and wherein the second radar detection result is an input to a controller associated with the first transmitter.

The second radar detection frequency range may be identical to or a subset of the first transmit frequency band.

The wireless communications system may further include a third radar detector within the second transceiver; wherein the third radar detector is configured to detect radars within at least a third time period, the third time period including at least a period of time when the first transmitter and the second transmitter both transmit coincident in time; wherein the third radar detector is configured to detect radars within a third radar detection frequency range; wherein the third radar detector communicates at least a third radar detection result via the second transmitter to the first receiver; and wherein the third radar detection result is an input to a controller associated with the first transmitter.

The wireless communications system may further include a cancellation circuit within the first transceiver, wherein the cancellation circuit is coupled to at least the first radar detector; and wherein the cancellation circuit adjusts a signal representative of the output of the first transmitter such that the adjusted signal in combination with a received signal for the first radar detector together result in a reduced level of first transmitter signal impairment to the first radar detector.

The wireless communications system may further include a second radio resource controller comprised within the second transceiver, wherein the second radio resource controller comprises the controller associated with the second transmitter; and wherein the second radio resource controller receives at least one additional link quality input as well as the first radar detection result to adjust at least one parameter associated with the second transmit channel.

The wireless communications system may further include a first radio resource controller comprised within the first transceiver, wherein the first radio resource controller comprises the controller associated with the first transmitter; and wherein the first radio resource controller receives at least one additional link quality input as well as the second radar detection result to adjust at least one parameter associated with the first transmit channel.

According to an aspect of the invention, a system is provided that includes a radio transmitter; and a radar detector to detect radar signals, wherein the radar detector is configured to detect radar on a radar detection listening frequency, the radar detector separated in distance from the radio transmitter such that the signal from the radio transmitter does not prevent the radar detector from detecting radar signals while the radio transmitter is emitting a transmit signal on the radar detection listening frequency, and wherein the radar detector is configured to communicate information to the radio transmitter if a radar is detected.

The radar detector may be a first radar detector and the system may further include a second radar detector to detect radar signals, wherein the second radar detector is configured to detect radar on a radar detection listening frequency, the second radar detector near enough to the radio transmitter such that signal from the radio transmitter prevents the second radar detector from detecting radar signals while the radio transmitter is emitting a transmit signal on the radar detection listening frequency, and wherein the second radar detector is configured to communicate information to the radio transmitter if a radar is detected.

The radio transmitter may operate at a transmit duty factor that is low enough that the second radar detector can detect radar. The second radar detector may perform radar detection listening on a transmit frequency of the radio transmitter prior to the radio transmitter emitting a signal on the radar detection listening frequency. The second radar detector may perform detection listening while the radio transmitter emits a signal on the radar detection listening frequency at a duty factor that is low enough that the second radar detector can detect radar.

The radar detector may perform radar detection listening while the radio transmitter emits a signal on the radar detection listening frequency. The second radar detector may perform radar detection listening while the radio transmitter emits a signal on the radar detection listening frequency at a duty factor that is low enough that the second detector can detect radar, and the first radar detector may perform radar detection listening while the radio transmitter emits a high duty factor signal on the radar detection listening frequency.

The second radar detector may perform radar detection listening on a frequency that is not the radio transmitter transmission frequency.

The radio transmitter may be a first radio transmitter and the system may further include a second radio transmitter that transmits on a different frequency than the first radio transmitter, and the second radar detector may perform radar detection listening on the transmit frequency of the first radio transmitter.

The first radar detector may receive from a less directive receive antenna pattern than the radio transmitter transmit antenna pattern.

According to another aspect of the invention, a system is provided that includes a plurality of transceivers, each of the plurality of transceivers comprising a receiver and a transmitter, and each of the plurality of transceivers having a radar detector co-located with the transmitter, wherein each radar detector operates in a different channel than the transmitter with which it is co-located.

The radar detector may communicate a radar detection status to at least one of the other of the plurality of transceivers.

Each radar detector may listen in a channel of a transmitter that is not the transmitter with which said radar detector is co-located. One radar detector may listen in a channel of a transmitter that is not the transmitter with which said radar detector is co-located and another radar detector may listen in a channel that is not used by any transmitters in the system.

The radio transmission term band refers to a range of frequencies for which operation is available. It may be the case that the operating channel, or occupied bandwidth of the transmission, entirely occupies the band, but more often, the operating channel occupies part of the band. It is often the case that a number of operating channels can occupy the band simultaneously. Furthermore, there are interference implications for operating channels to simultaneously occupy the band because even though they may be non-overlapping, there is limited filtering available that can prevent an impact that one transmission has on the reception of another if they are near each other. A band usually refers to an entity larger than a single channel, and the channel locations may be pre-designated so as to minimize potential overlap, or they may be arbitrarily placed on a grid that depends on the technology used. A radio may search for the best channel among available channels to determine the best one to use in the operating environment to get the desired performance. A sub-band refers to major splits of the band which get pre-designated for a purpose which is generally technology dependent, such as a sub-band for uplinks and a sub-band for downlinks, where the channels within these sub-bands get selected by the equipment. Sub-bands, if used, are also generally an entity larger than a channel and which comprise one or more channels. Most regulatory agencies identify bands or sub-bands that a specific set of rules apply to. More than one band may be used for equipment. In an exemplary embodiment, to get separation between uplink and downlink channels one band may be used for an uplink and another band used for a downlink. The bands may have different regulatory requirements.

One radar detector may listen in part of a band or sub-band of a transmitter that is not the transmitter with which said radar detector is co-located and another radar detector may listen in another part of the band or sub-band occupied by a transmitter that is not the transmitter with which said radar detector is co-located.

At least one of the radar detectors may listen on a channel that is not occupied by a transmitter of the system for part of the time the at least one of the radar detectors listens.

The bandwidth of a radar detected by the radar detector is determined and only a bandwidth in the system related to the bandwidth of the detected radar is vacated. The related bandwidth in the system may be the same as the bandwidth of the detected radar. The related bandwidth in the system may be one selected from the group consisting of half, double and quadruple the bandwidth of the detected radar.

According to a further aspect of the invention, a system is provided that includes a plurality of transceivers, the plurality of transceivers comprising a first transceiver, the first transceiver comprising a receiver and a transmitter and a first radar detector co-located with the transmitter, wherein the first radar detector first operates in a transmit channel of the transmitter of the first transceiver and then operates in a transmit channel of another of the plurality of transceivers.

A radar detector serves the purpose of detecting the presence of radars that would be interfered with by the transmitter that the radar detector is working for. The radar detector produces a radar detection result. The radar detection result can be polled or can be pushed from the radar detector. One example is status derived from a signal line such as a general purpose I/O line or logic signal that indicates that a radar is present, or is not present, and if it is present, it may indicate some information about the nature of the radar measurement results that it made, such as the radar center frequency, radar bandwidth, or category of radar type. Another example is a message or control frame sent over a communications interface from the radar detector to some other controller entity with the system that comprises fields that describe if a radar is present, or is not present, and if it is present, it may indicate some information about the nature of the radar measurement results that it made, such as the radar center frequency, radar bandwidth, or category of radar type. This message can be used to make adjustments to at least one adjustable parameter of the transmitter the radar detector is working for such as the transmit channel number (or numbers), the transmit channel center frequency (or frequencies), the transmit channel bandwidth (or bandwidths), and the transmit channel power (or powers). That adjustment may be a result of the message or signal from the radar detector being converted in format and sent to a controller for the transmitter. The controller for the transmitter may also take several forms. If it is a simple controller, then upon seeing the message that the radar detection occurred in the occupied bandwidth of the transmitter, then the transmission in that bandwidth will be stopped. There is generally a regulatory requirement for how long a radio can take before the transmitter is prevented from further transmissions. A more complex form of control would be if a radio resource controller used the radar detector as an input along with another input (or inputs) such as described in U.S. patent application Ser. No. 13/645,472 or U.S. Provisional Patent Application Ser. No. 61/910,194 and incorporated herein to make decisions such as what the next course of action is besides preventing further transmissions in the channel where the radar detection occurred. An exemplary course of action would be to decide the next channel to go to or a different occupied bandwidth to use and to use the remaining allowed time on the air to communicate that information or negotiate the best alternative among the radios involved. The radio resource controller can utilize information about alternatives combined with the radar detection results to help determine the next step.

The first radar detector may be configured to communicate results of a radar detection status to a transmitter of at least one other transceiver of the plurality of transceivers.

The system may further include a second radar detector, the second radar detector configured to listen for radar on the transmit channel of the transmitter of the first transceiver. The second radar detector may communicate results of a radar detection status to control the transmitter of the first transceiver. An aggregation point of the system may use the information from the first radar detector and the second radar detector to determine radar detection results.

The system may further include a third detector, the third detector configured to listen for radar on the transmit channel of the transmitter of the first transceiver. The third radar detector may communicate results of radar detection status to control the transmitter of the first transceiver. An aggregation point of the system may use the information from the second radar detector and the third radar detector to determine radar detection results.

According to another aspect of the invention, a radio transceiver is disclosed that includes a receiver; a transmitter; a radar detector co-located with the transmitter, wherein the radar detector operates in a different channel than the transmitter with which it is co-located.

The radar detector may communicate information about a radar detection to another radio transceiver in communication with the radio transceiver.

The radar detector may listen in a channel of a transmitter that is not the transmitter with which said radar detector is co-located.

The radar detector may listen in a channel of a transmitter that is not the transmitter with which said radar detector is co-located and another radar detector may listen in a channel that is not used by any transmitters in a network.

The radar detector may listen in part of a band or sub-band of a transmitter which is not the transmitter with which said radar detector is co-located and another radar detector listens in another part of the band or sub-band occupied by a transmitter which is not the transmitter with which said radar detector is co-located.

The radar detector may listen on a channel that is not occupied by the transmitter for part of the time the radar detectors listens.

The radio transceiver may be configured to determine a bandwidth of a radar detected by the radar detector and vacate a bandwidth related to the bandwidth of the detected radar.

According to yet another aspect of the invention, a radio transceiver is disclosed that includes a receiver; a transmitter; and a radar detector co-located with the transmitter, wherein the radar detector first operates in a transmit channel of the transmitter and then operates in a transmit channel of another radio transceiver.

The radar detector may be configured to communicate results of a radar detection to a transmitter of another radio transceiver.

A second radar detector in another radio transceiver may listen for radar on a transmit channel of the transmitter.

The second radar detector may communicate results of a radar detection to control the transmitter.

The radar detector may communicate information to an aggregation point, said aggregation point using the information from the radar detector and the second radar detector to determine radar detection results.

A third radar detector co-located with another radio transceiver may listen for radar on the transmit channel of the transmitter.

The transmitter may receive results of radar detection status from the third radar detector.

An embodiment of the invention is to make a radar detector that has high antenna gain in every required direction in azimuth and/or across various elevations simultaneously which would allow a detection of a wideband radar signal at long range.

Another embodiment of the invention is to time multiplex directional antenna beams with sufficient duty factor that radars can still be detected.

Another embodiment of the invention is a radar detector that uses multiple directional antenna elements that are individually directed over the required azimuth and elevation and that the directional elements are combined into multiple beams with increased directional gain, and taken together the higher gain beams cover the full required angle of arrival of possible radar signals that have to be detected.

Another embodiment of the invention is that the multiple beams are created with either beamforming phase and amplitude modification elements or with a FFT processor performing a spatial Fourier transform where each output bin is a sample stream of a beam of the multi-beam antenna system.

Another embodiment of the invention is that each output bin of the FFT or other multi-beam processing in the exemplary radar detector is passed to a radar detection circuit so that multiple radar detection circuits are operating, each processing a signal received with high antenna gain in each of the intended directions.

Another embodiment of the invention is that the exemplary radar detector may be remotely located from the radio and have a communication mechanism to the radio, either wired or wireless. The detection results processed from any of the radar detection beam outputs can be combined in communicating the results to the radio.

Another embodiment of the invention is that the exemplary radar can be directed to a subset of the entire azimuth and elevation direction to detect a radar in the direction of a directional antenna that the radio uses to protect the radar from the radio interference.

Another embodiment of the invention is that beams created by the set or a subset of antennas are directed to a subset of the entire azimuth and elevation direction to concentrate antenna gain from one or more beams in the direction of a suspected radar, which may be suspected due to an earlier detection, in order to verify the presence of the radar with higher signal to noise ratio.

Another embodiment of the invention is that the task of examining angles of elevation, azimuth and sampling over time, may be distributed among more than one radar detector operating in parallel, in different locations, and the results taken individually or combined.

Another embodiment of the invention is that each beam of the multi-beam antenna system is fed to another FFT in order to provide a filter bank that breaks up the spectrum of the search bandwidth into filtered bins to be passed to radar pulse and detection apparatus.

An embodiment of the invention discloses that a victim-signal detector makes a determination of the types and levels of RF energy in detector bands, which are one or more bands adjacent to the operating frequency band.

Another embodiment of the invention discloses that the result of said determinations is used to set the configuration of a first operating transmitter to use certain channels in the operating frequency band in a way that will adjust the amount of OOBE in one or more of the victim-signal frequency bands.

Another embodiment of the invention discloses that said configuration includes selection of an operating channel for the operating transmitter.

Another embodiment of the invention discloses that said configuration includes adjustment of transmit power for the operating transmitter or adjustment of its effective radiation pattern.

Another embodiment of the invention discloses that said configuration includes selection of a filtering characteristic for the operating transmitter.

Another embodiment of the invention discloses that said configuration includes selection of a transmit channel bandwidth for the operating transmitter.

Another embodiment of the invention discloses that said configuration includes prevention of transmission for the operating transmitter or adjustment of its transmit duty cycle.

Another embodiment of the invention discloses that said determination of the presence of specified types of RF energy may be performed by a victim-signal detector associated with the operating transmitter.

Another embodiment of the invention discloses that said victim-signal detector associated with the operating transmitter may be an operating receiver within the same radio or radio system.

Another embodiment of the invention discloses that said victim-signal detector may be a receiver of the operating channel transmit signal.

Another embodiment of the invention discloses that said victim-signal detector may be an RF signal receiver that is not part of the transmit-receive link of the operating channel transmit signal.

Another embodiment of the invention discloses that the amount of adjustment of OOBE in one or more of the victim frequency bands is related to said determination of the specified types and levels of RF energy in detector bands.

Another embodiment of the invention discloses that the amount of adjustment of OOBE at different frequencies in one or more of said victim frequency bands is related to said determination of the specified types and levels of RF energy at corresponding said frequency or frequencies.

Another embodiment of the invention discloses that said determination of specified types and levels of RF energy comprises measurements of features of the energy waveform.

Another embodiment of the invention discloses that said features of the energy waveform comprises pulses.

Another embodiment of the invention discloses that said pulses that are said features of the energy waveform are characterized by measurements of absolute amplitude.

Another embodiment of the invention discloses that said pulses that are said features of the energy waveform are characterized by measurements of relative amplitude.

Another embodiment of the invention discloses that said pulses that are said features of the energy waveform are characterized by measurements of amplitude relative to a level determined by other signals in the environment.

Another embodiment of the invention discloses that said pulses that are said features of the energy waveform are characterized by measurements of the amplitude of the level between the pulses.

Another embodiment of the invention discloses that said pulses that are said features of the energy waveform are characterized by measurements of the amplitude from pulse to pulse.

Another embodiment of the invention discloses that said pulses that are said features of the energy waveform are characterized by measurements of the sequencing and grouping of pulses.

Another embodiment of the invention discloses that said pulses that are said features of the energy waveform are characterized by measurements of pulse width and pulse repetition intervals or pulse repetition frequencies.

Another embodiment of the invention discloses that said features of the energy waveform include a pilot signal with characteristics in time.

Another embodiment of the invention discloses that said features of the energy waveform include a pilot signal with characteristics in frequency.

Another embodiment of the invention discloses that said features of the energy waveform include a pilot signal with characteristics in shape.

Another embodiment of the invention discloses that said features of the energy waveform include a pilot signal with characteristics designated by a specific user in the band that requires detection.

Another embodiment of the invention discloses to use multiple detectors.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is an illustration of intelligent radio transceivers (IBRs) deployed for cellular base station backhaul with obstructed LOS according to one embodiment of the invention.

FIG. 2 is a block diagram of an IBR according to one embodiment of the invention.

FIG. 3 is a schematic diagram showing radar detection according to one embodiment of the invention.

FIG. 4 is a schematic diagram showing radar detection according to another embodiment of the invention.

FIG. 5 is a schematic diagram showing radar detection according to a further embodiment of the invention.

FIG. 6A is a timeline showing a radar detection process according to one embodiment of the invention.

FIG. 6B is a timeline showing a radar detection process according to another embodiment of the invention.

FIG. 7 is a block diagram showing radar detection according to one embodiment of the invention.

FIG. 8 is a block diagram showing radar detection according to another embodiment of the invention.

FIG. 9 is a block diagram showing radar detection according to a further embodiment of the invention.

FIG. 10 is an illustration of the beam patterns of the multi-beam antenna system of an exemplary embodiment of the instant invention for a radar detector.

FIG. 11 is an illustration of an exemplary radar detector with the beams confined to one direction in order to verify a detection or to limit the detection angle.

FIG. 12A is a schematic diagram of an exemplary embodiment of the antenna array where a circular array of dipole antenna elements is used.

FIG. 12B is a block diagram illustrating a set of antenna elements that are downconverted through the RF translator stage, sampled, and combined in a spatial FFT to form the simultaneous multiple beams.

FIG. 13 is a block diagram illustrating how the output of the exemplary embodiment of the N-Point Complex FFT producing direction beam outputs are passed through radar pulse detection and radar decision apparatus and aggregated in a communication processor for relaying to the radio.

FIG. 14 is a block diagram illustrating an exemplary embodiment where an M-Point Complex FFT is used for each beam output of the N-Point Complex FFT.

FIG. 15(a) is an illustration of the very low level of OOBE and high relative filtering required when an OOBE signal is detected.

FIG. 15(b) is an illustration of by contrast to FIG. 15(a) of the relieved level of OOBE that can be accommodated when there is no OOBE signal detected.

FIG. 16 is an illustration of the relieved level of OOBE using a relative specification instead of an absolute specification.

FIG. 17 is an illustration of an operating radio transmitter, a OOBE victim-signal detector and a victim transmitter/receiver where the receiver can potentially be interfered with by excessive OOBE.

FIG. 18 is an illustration of an operating radio transmitter, a pair of cooperating OOBE victim-signal detectors and a victim transmitter/receiver.

### DETAILED DESCRIPTION

In a radio system that can have multiple radar detectors, such as a point-to-multipoint and other configurations in the array of backhaul networks, the radar detectors become a shared network resource. Embodiments of the invention make use of the shared resource by operating these detectors cooperatively, or in a coordinated manner, to perform the radar detection function efficiently and provide expanded capability such as channel look ahead, extended detection bandwidth, and more reliable detectability through location, angle, and antenna diversity.

Embodiments of the invention perform radar detection at the receiver side for the transmitter that occupies the channel at the same time the transmitter is sending. In some embodiments of the invention, the detector relays the results over a separate communications channel. This separate communications channel may be the part of an FDD link that operates in the other direction. The communication may also be indirect. For example, in some embodiments, communications may be attempted on a channel, and by virtue of not receiving a signal, it may be deduced that the channel is blocked due to radar detection. In another example, in some embodiments, a radar detector may transmit messages that a channel is clear on the channel, and, if radar is detected on the channel, the radar detector stops sending the messages from which it can be determined by transmitters that the channel is blocked due to radar detection.

Embodiments of the invention are also directed to operation of a radar detector in a full duplex system that transmits on the same channel at high duty factor so the detection is preferably performed remotely. This high-duty-factor system is able to determine the actual operating bandwidth required to be vacated in order to protect the detected radar.

Additionally, one or more radar detectors can be task-shared or time-shared so the detector or part of the detector can be reused while monitoring a high-duty-factor transmission system. An exemplary requirement for task sharing is to be able to use the same radar detector to perform monitoring of one channel while time-sharing the detector by performing an alternate channel CAC on another channel at a low duty factor. A background CAC may be performed for an alternate channel that can be used immediately in the event of a radar detection. This alternate channel detection is not disrupted by the adjacent or alternate channel operation of the occupied channel which may be operating at high duty factor.

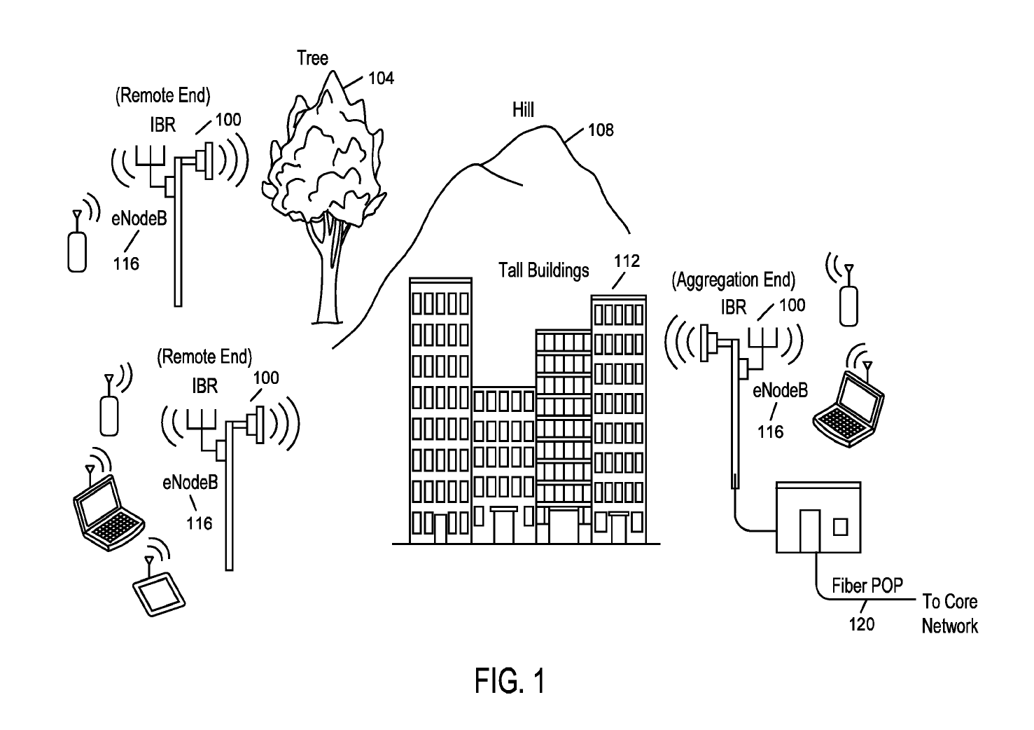

FIG. 1 illustrates deployment of exemplary intelligent backhaul radio transceivers (IBRs) in accordance with an embodiment of the invention. As shown in FIG. 1, the IBRs 100 are deployable at street level with obstructions such as trees 104, hills 108, buildings 112, etc. between them. The IBRs 100 are also deployable in configurations that include point to multipoint (PMP), as shown in FIG. 1, as well as point to point (PTP). In other words, each IBR 100 may communicate with more than one other IBR 100.

For 3G and especially for 4^{th} Generation (4G), cellular network infrastructure is more commonly deployed using “microcells” or “picocells.” In this cellular network infrastructure, compact base stations (eNodeBs) 116 are situated outdoors at street level. When such eNodeBs 116 are unable to connect locally to optical fiber or a copper wireline of sufficient data bandwidth, then a wireless connection to a fiber “point of presence” (POP) requires obstructed LOS capabilities, as described herein.

For example, as shown in FIG. 1, the IBRs 100 include an Aggregation End IBR (AE-IBR) and Remote End IBRs (RE-IBRs). The eNodeB 116 of the AE-IBR is typically connected locally to the core network via a fiber POP 120. The RE-IBRs and their associated eNodeBs 116 are typically not connected to the core network via a wireline connection; instead, the RE-IBRs are wirelessly connected to the core network via the AE-IBR. As shown in FIG. 1, the wireless connection between the IBRs include obstructions (i.e., there may be an obstructed LOS connection between the RE-IBRs and the AE-IBR).

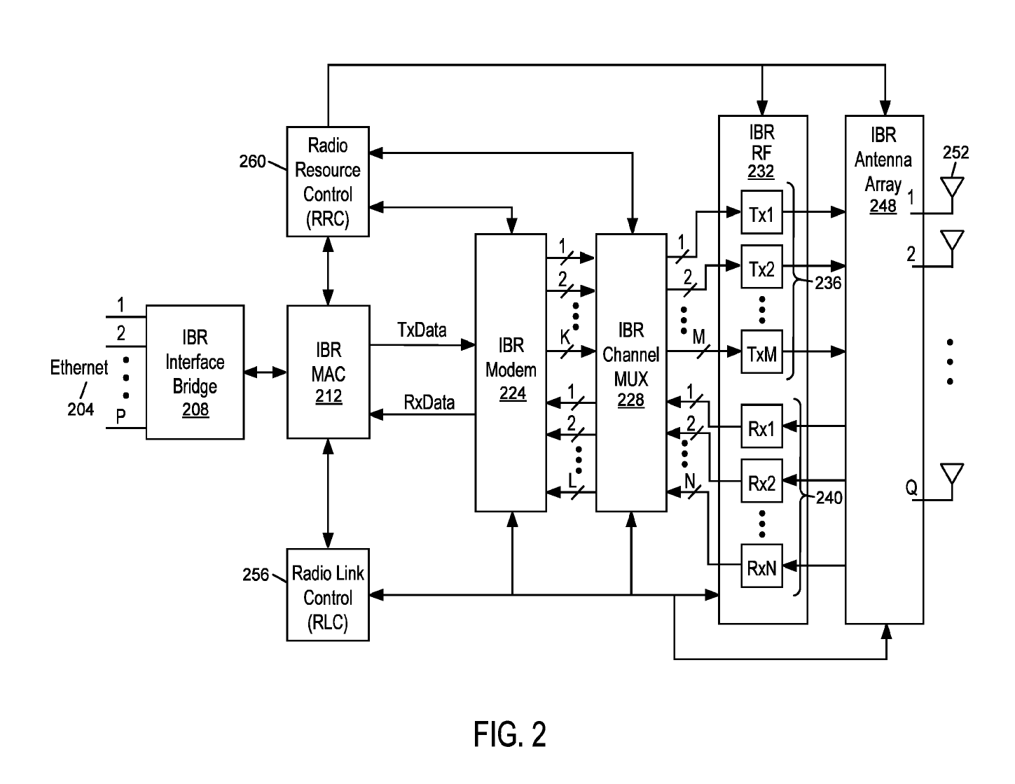

FIG. 2 illustrates an exemplary embodiment of the IBR 100 shown in FIG. 1. In FIG. 2, the IBR 100 includes interfaces 104, interface bridge 108, MAC 112, modem 124, channel MUX 128, RF 132, which includes Tx1 TxM 136 and Rx1 RxN 140, antenna array 148 (includes multiple antennas 152), a Radio Link Controller (RLC) 156 and a Radio Resource Controller (RRC) 160. It will be appreciated that the components and elements of the IBRs may vary from that illustrated in FIG. 2. Additional details regarding the intelligent backhaul radio transceiver (IBR) are provided in commonly assigned U.S. patent application Ser. No. 14/988,578, U.S. Pat. No. 9,055,463, U.S. Pat. No. 8,811,365, U.S. Pat. No. 8,311,023 and U.S. Pat. No. 8,238,318, the disclosures of which are hereby incorporated herein by reference in their entirety. Furthermore, additional details of antenna arrays suitable for such radio transceivers are provided in commonly assigned U.S. patent application Ser. No. 14/837,797, filed Aug. 26, 2015, U.S. Pat. No. 9,178,558, U.S. Pat. No. 9,001,809, U.S. Pat. No. 8,824,442 and U.S. Pat. No. 8,467,363, and commonly assigned U.S. patent application Ser. No. 14/559,859, filed Dec. 3, 2014, U.S. Pat. No. 8,872,715 and U.S. Pat. No. 8,928,542, the disclosures of all of which are hereby incorporated herein by reference in their entirety.

The Intelligent Backhaul Radio transceiver (IBR) 100 is used in a point-to-point or point-to-multipoint connection that can be used for any radio interface that requires high throughput, including backhaul of cellular sites, connectivity among entities within an enterprise, Internet to enterprise, or Internet to customer premises equipment, campus networks, connectivity among stations in metropolitan area networks, and connection between Local Area Networks and Internet service.

Embodiments of the invention perform detection of radar signal sources that would be interfered by, or interfere with, the IBR. An exemplary embodiment of the required dynamic frequency selection (radar) requirement in regulatory environments, such as the U.S. and Europe that is used for detecting radars by the IBR equipment while operating radio links at a high duty factor, is used to describe embodiments of the invention.

There are significant advantages to effectively performing the radar detection for each transmitter at the receiver side for the array of wireless networked backhaul applications, such as the exemplary point-to-point and point-to-multipoint systems. In fact, for high duty factor FDD point-to-point systems, the radar detection results obtained when at least one radar detector is also co-located at the FDD receivers and when the radar detector has a less directional radar detection antenna than the transmit signal antenna are better for both operation of the radio link and for minimizing any potential interference with the radars due to the instant radio link than when the radar detection is performed only at the transmitter as known in other types of systems.

Because of the range difference, a radar positioned behind the receiver is closer to the detector than to the interfering radar transmitter. Because the radar detector antenna is omnidirectional or less directional than the radio link directional antennas, a radar located to the side of the pair or behind the transmitter is detected at the receiver before it is interfered with by the transmitter. The transmitter signal is reduced in level at the radar due to the directionality of the antenna, while the radar signal arrives full force at the radar detector.

Also, in an FDD radio using a radar detector co-located with the receiver, the detector can listen for the radar for 100% duty factor. This creates a peak-detection capability that insures the detector finds the largest radar signal of the time varying channel, overcoming the loss of multipath fading and a rotating radar detection antenna. For these reasons, embodiments of the invention are advantageous because the detectability of the radar is better both in the sense that actual radars are more reliably detected and in the sense that accidental false detections of non-existent radars are greatly reduced.

In an exemplary embodiment, the radio uses a separate radar detection circuit which is made from a commercial WiFi chip and which has its own antenna. The radar detection circuit inside the WiFi chip is used for the radar detection. It may or may not share a common RF signal path with the main operating antennas. There is a benefit in radar detectability if the radar detector antenna field is less directional than that of the actual signal antennas. In one extreme example, the radar detector antenna is omnidirectional or omnidirectional in azimuth, and the transmit signal antenna is a moderate or high gain antenna. The gain difference creates a bias for detection of radar signals versus interference from the transmit signal for radar angles that are behind or on the side of the radar mainlobe.

In an exemplary embodiment with a different band used for each transmit direction in a point-to-point or multi-point-to-point link, and which requires radar detection on each band or sub-band, the radar detection performs both initial CAC and in-service monitoring, but in different ways and at different times. Upon initial bootstrapping of the link, the CAC for each radio is performed at its local transmit frequency so the local transmitter can be informed of the result, since there is no link in the other direction yet. Then, after the radios establish a connection and are operating at high duty factor, the radar detector in each transceiver switches listening frequency and in-service monitoring is performed at the local receive frequency to listen for radars and so perform in-service monitoring for the transmitter sending from the other radio. More specifically, the in-service monitoring for the downlink transmitter happens at the downlink receiver in point-to-point or at the downlink receivers in multi-point-to-point, and the in-service monitoring for the uplink transmitter (or transmitters) happens at the uplink receiver. This is to satisfy the requirement for near 100% duty factor transmission while detecting at a level that is much lower than the transmit level. The results of the in-service monitoring are communicated along the opposite link direction to the transmit side which the monitoring was being performed for (i.e. the downlink communicates the uplink radar detection information and the uplink communicates the downlink radar detection information). If, for example, the uplink radar detector senses a radar signal, it notifies the uplink transmitter through the downlink radio set. In an exemplary embodiment, a controller, such as a radio resource controller, within the transceiver having the uplink transmitter can use this exemplary radar detection result along with other link quality inputs such as estimates of other uncoordinated interference levels observed over frequency, time, space or cancellation capability as described in U.S. Provisional Patent Application Ser. No. 61/910,194, the entirety of which is incorporated herein by reference, to optimally adjust parameters such as the uplink transmit channel center frequency, transmit channel bandwidth and/or transmit power.

The exemplary embodiments of the invention may be best understood in the context of a design example. It will be appreciated that other designs can be used, and the exemplary design example is not meant to be limiting in any way.

The exemplary radio link includes two full duplex transceivers, typically mounted on poles and separated by a large distance, such as five hundred meters to several kilometers. It will be appreciated that the distance may be less than or more than five hundred meters or may be less than or more than several kilometers. One transmission direction operates in the upper part of the allocated RF band, called the upper band or sub-band, and other in the lower part of the allocated RF band, called the lower band or sub-band. The point-to-point or multi-point-to-point link in the example uses one radio designated as the downlink transmitter (using the lower part of the band) and the other as the uplink transmitter (using the upper part of the band). Each radio transceiver has a separate radar detection sensor co-located with it.

Even though the exemplary FDD operation divides this frequency band into a lower and upper band or sub-band, other implementations also can work, including, for example, overlapping bands or sub-bands, also known as Zero Division Duplexing (or ZDD) such as described in U.S. patent application Ser. No. 14/572,725, U.S. Pat. No. 8,948,235, U.S. Pat. No. 8,638,839 and U.S. Pat. No. 8,422,540, the disclosures of which are hereby incorporated herein by reference in their entirety. Within each band or sub-band the exemplary radios negotiate an operating frequency in each direction, one direction per band or sub-band. The exemplary radios use multiple transmit and receive antennas (MIMO) in each direction, and split the available transmit power among the transmit antennas or can operate with MISO, SISO, or SIMO operation. In such FDD or ZDD wireless communication systems, the transmitters in either of the uplink or downlink directions of point-to-point or multi-point-to-point systems transmit for some or all of each frame coincident in time meaning that both an uplink transmitter and a downlink transmitter are both transmitting at the same time possibly within different bands or sub-bands, possibly within the same band or sub-band or possibly even within the same channel. The remainder of this discussion will refer to these exemplary embodiment radios for purpose of explanation only, recognizing that there are many wireless communication system embodiments that can benefit from the invention.

The radio, based on an exemplary controller implemented with software and/or hardware, determines the operating frequency, within the constraints of satisfying any uniform channel usage requirement, performs medium access control using energy detection, and performs the Channel Availability Check (CAC). The CAC is a pre-scan of the channel to detect the presence of radars prior to allowing the equipment to transmit. The radio then monitors its channels using in-service monitoring. In some embodiments, the radio also monitors simultaneously for other potential interference sources, whether in-channel or out-of-channel, as described in U.S. patent application Ser. No. 14/688,550, filed Apr. 16, 2015 and U.S. Pat. No. 9,049,611, the disclosures of which are hereby incorporated herein by reference in their entirety.

In an exemplary embodiment, there is a brief period of time after the radar detector in the radio housing containing the downlink radio unit performs the CAC where it remains on the transmitter channel for in-service monitoring, while the transmitter channel operates at low duty factor to facilitate the detection synchronization and acquisition of the transmit signal by the other radio(s), and communicating to the other radio(s) what channel it would like to operate on. This is a bootstrap mode of operation. Once the communication link is established, the radar detector frequency channel is switched as described above so that it is listening on the receive channel to perform in-service monitoring for the transmitter in the other radio.

In a radar detection listening process, the radar detector attempts to receive signals transmitted from radars. In some embodiments, a radar detection message, control frame or status is transmitted by the radar detector if a signal received at the radar detector sufficiently matches one of a set of designated radar waveforms.

In some embodiments, the effective interference bandwidth of the radar receiver is determined. The effective interference bandwidth may be different than the occupied bandwidth of the radar transmit signal by some margin. In that case, only the effective interference bandwidth is vacated—instead of vacating a larger percentage of the overall frequency band for the required period of time (typically, 30 minutes). It will be appreciated that the period of time need not be limited to the minimum required by regulations. In some embodiments, the transceivers may remain off the channel for an extended period of time. The communication from the radar detector to the transmitter carries information related to the bandwidth that must be vacated.

In an exemplary embodiment, the effective interference bandwidth is determined by measuring the characteristics of the pulses that comprise the radar waveform to estimate what the radar receiver signal bandwidth is. A function is applied to the measured characteristics that adjusts for the ratio of radar receiver interference bandwidth at an anticipated excess interference power to radar receiver signal bandwidth required to process the radar pulse. The radar receiver interference bandwidth that is calculated is the bandwidth that needs to be vacated around the radar center frequency. In an exemplary embodiment, the function is a simple scaling by a constant. In some embodiments, the function depends on the type of radar signal that is detected and/or the excess power level of the detected radar signal over a minimum radar detection threshold. In an exemplary embodiment, the radar signal bandwidth is the inverse of the radar pulse period measured between the half-way points of the rising and falling edge. These are exemplary embodiments and other embodiments can use other methods for estimating the radar receiver bandwidth and applying various functions to the result are also anticipated.

In an exemplary embodiment, radar detection is performed on an alternate channel on a continued basis such that if a radar detection occurs on the operating channel, the alternate channel is available for more immediate occupancy because all or part of the CAC period is already accomplished. In another exemplary embodiment, after a sufficient CAC period has passed for the alternate channel to be useable, it is continually monitored for radars in order to keep the CAC information fresh. This alternate channel may be near the occupied channel and may encounter a similar, albeit reduced, level of interference from the transmitter. Therefore, in a high duty factor transmission radio link, the alternate channel monitoring can be done, at least for small channel separation, at a remote location so the transmission signal is attenuated. The communication between the alternate channel radar detection and the transmitter is kept fresh such that at least the regulatory impact for timeliness of the information is maintained. In an exemplary embodiment, a point-to-point radio link places both the in-channel radar detector and the alternate-channel radar detector in the receiver or remote detector that can communicate back to the transmitter. In another exemplary embodiment, a point-to-multipoint (or multi-point-to-point) radio link uses the radar detector in one receiver for in-channel detection and the radar detector in another receiver for alternate channel detection.

In an exemplary embodiment, one or more radar detectors that can operate while a high-duty-factor transmitter is transmitting perform time multiplexing between radar detection on the operating channel and radar detection on an alternate channel. In a further exemplary embodiment, the CAC operation is performed while listening for a partial duty factor for a total CAC time longer than the full duty factor CAC time, and at for least a period of time related to the partial duty factor fraction. In an exemplary embodiment, the length of the partial duty factor check time is at least the CAC time divided by the fractional duty factor. In an exemplary embodiment, a point-to-multipoint radio link uses the radar detector in one receiver for in-channel detection and the radar detector in another receiver for alternate channel detection and time-multiplexes one or both for additional alternate channel coverage to provide multiple alternate channel options.

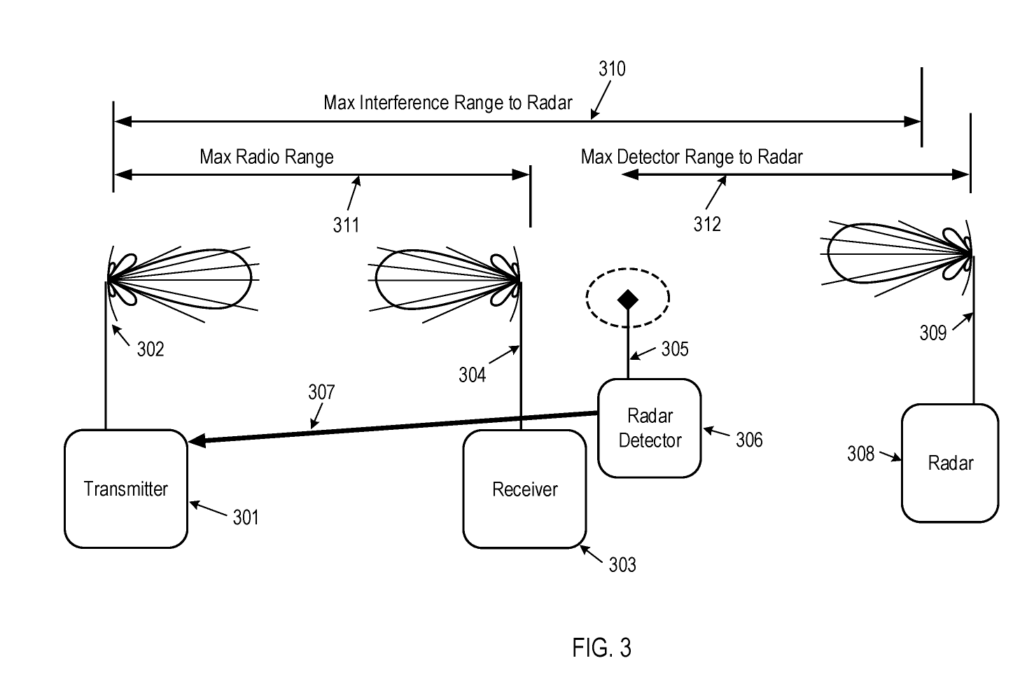

FIG. 3 shows a schematic representation of a one-way radio link according to some embodiments of the invention. In FIG. 3, the radio link includes a transmitter 301 with a directional antenna 302, a receiver 303 with a directional antenna 304, and a radar detector 306 with an omnidirectional antenna 305. In one embodiment, one or both of the transmitter 301 and receiver 303 are within an IBR transceiver as shown in FIG. 2. A communication link 307 between the radar detector 306 and the transmitter 301 is used to communicate the results of any radar detection or non-detection from the radar detector 306 to the transmitter 301.

One problem with existing networks is that when the transmitter is transmitting, the high signal level swamps out the receive signals for typical receivers that are located in close proximity to the transmitter, thereby limiting the ability for a radar detector co-located with the transmitter to detect a radar signal. A co-located radar detector is one that is in close enough proximity to the transmitter that when antenna configurations are accounted for, the radar detector cannot detect a radar signal at the required level, as typically set by the appropriate regulatory authority, while the transmitter is transmitting. A radar detector is transmit-impaired if the signal from the transmitter prevents the radar detector from detecting radar signals at or above the regulatory limit while the impairing transmitter is emitting its transmit signal. A radar detector is not transmit-impaired if it can still detect radar signals at or above the regulatory limit while the transmitter is emitting its transmit signal. The transmitter may emit its transmit signal in the same channel as the radar detector to impair the radar detection, or the transmit signal may be emitted in a nearby channel, even if such nearby channel is in a different frequency band, and still impair the radar. The impairment can be prevented by separating the radar detector in distance from the transmitter, or by using a directional transmit antenna or directional radar-detector-receive antennas to reduce the impinging signal on the radar detector, or any other means to reduce the transmit signal level, including a cancellation circuit for cancelling the transmit signal at the input of or within the radar detector using, for example, techniques described in U.S. patent application Ser. No. 14/572,725, filed Dec. 16, 2014, U.S. Pat. No. 8,948,235, U.S. Pat. No. 8,638,839 and U.S. Pat. No. 8,422,540, the disclosures of which are hereby incorporated herein by reference in their entirety.

In FIG. 3, a radar 308 with a directional antenna 309 is also shown. The radar 308 is shown relative to the range scales 310-312. The range scales include a maximum interference range to the radar 310, which is a range showing the maximum distance from the transmitter 301 to avoid interference with the radar 308. The range scales also include a Max Radio Range 311, which is the maximum distance from the transmitter 301 to the receiver 303. The range scales also include a Max Detector Range to Radar 312, which is the maximum distance that the detector 306 can detect radar. The radar detector 306 detects radar from the radar 308 in a range that is longer than the range at which the radio transmitter 301 interferes with the radar 308.

In operation, when the transmitter 301 operates at a high duty factor at the Max Radio Range 311, the radar detector 306 can detect the radar 308 at a range less than the Max Detector Range to the Radar 312. The Max Detector Range to the Radar 312 is the range at which the transmitter 301 would not interfere with the radar 308 receiver operation over the Max Interference Range to Radar 310.

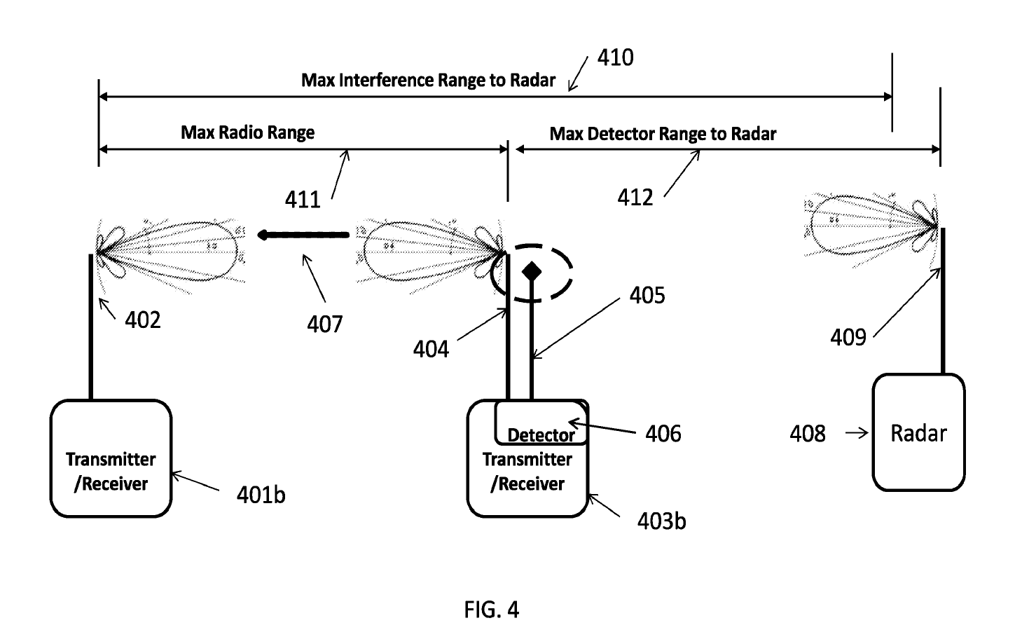

FIG. 4 shows a schematic representation of a radio link in accordance with some embodiments of the invention. In FIG. 4, the radio link includes a first transceiver 401 having an antenna 402 and a second transceiver 403 having an antenna 404. The second transceiver 403 includes a radar sensor/detector 406. The radar detector 406 is co-located with the transmitter of the second transceiver 403.

In the embodiment of FIG. 4, the radar detector 406 communicates back to the transmitter 401 using the radio transmission link between the first transceiver 401 and the second transceiver 403. In particular, in FIG. 4, the radar results are communicated over the operational channel in the transmitter in transceiver 403 to the receiver in transceiver 401. The radar detector 406 is shown as located in the same unit as transmitter/receiver 403 and controls the communication link 407.

It will be appreciated that a full duplex radio link with radar detection occurring on each side (the transmit side and the receive side), may be constructed from two or more links of this nature.

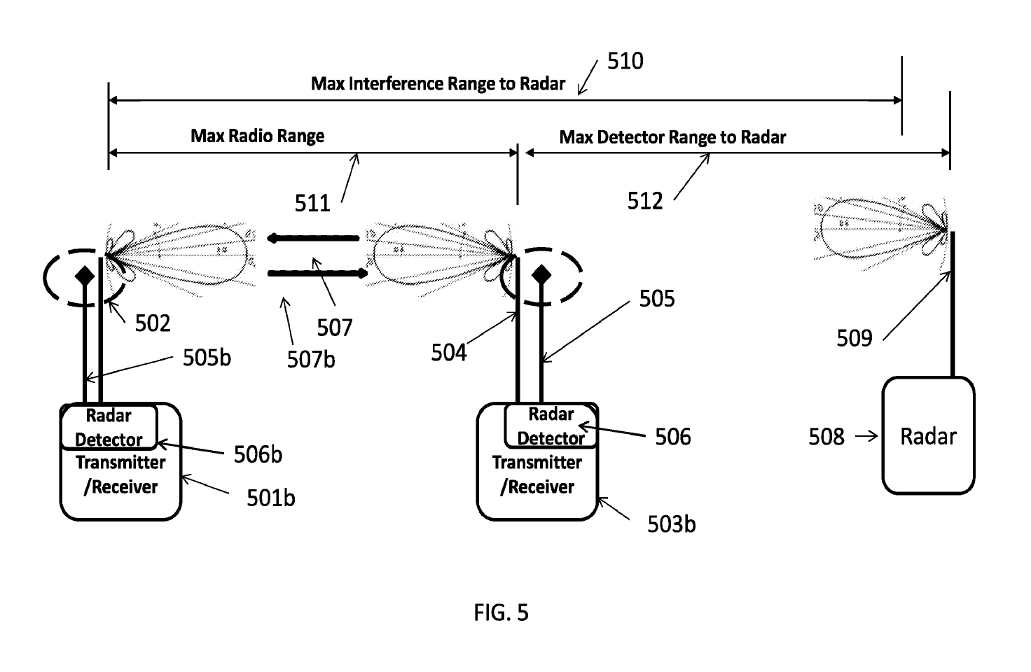

FIG. 5 is a schematic representation of a radio link according to other embodiments of the invention. In FIG. 5, a radar detector 506a, 506b is provided in each transceiver 501, 503. The arrangement of FIG. 5 allows the use of the radar detectors 506 to operate as an in-service monitor on each link 507a, 507b and perform CAC and bootstrap in-service monitoring for its own link 507a, 507b.

In FIG. 5, first transceiver 501 includes a first radar detector 506a, and the second transceiver 503 includes a second radar detector 506b. A first communication link 507a is provided between the transmitter of the first transceiver 501 and the receiver of the second transceiver 503, and a second communication link 507b is provided between the transmitter of the second transceiver 503 and the receiver of the first transceiver 501. The communications links 507a and 507b are the transmission channels between the transceivers 501, 503.

In operation, the radar detector 506a communicates the results of its radar detection operations to the transceiver 503 using communications link 507a, and the radar detector 506b communicates the results of its radar detection to the transceiver 501 using the communications link 507b. The radar detection status results may be communicated on the transmission channel, for example, in the main data stream, the control block, or any method of signaling the information.

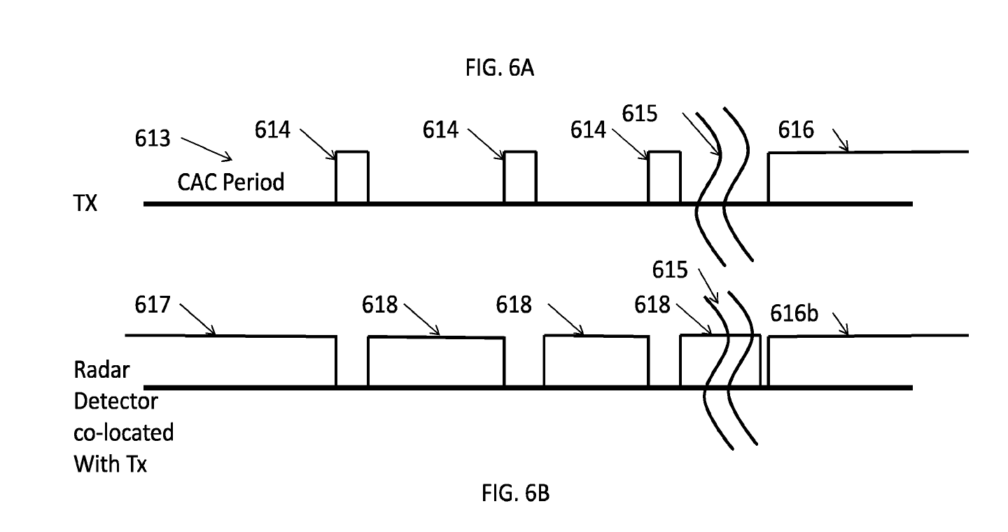

FIGS. 6A and 6B are time lines showing the radar detection operations for an exemplary link according to embodiments of the invention. In FIG. 6A, the timing operations of the transmitter are shown, and, in FIG. 6B, radar detection timing of a co-located radar detector is shown.

At a high-level, as shown in FIG. 6A, a CAC period 616 is followed by the low duty factor transmit periods for bootstrap, the low duty factor transmit periods for bootstrap 614 are followed by a time break 615, and the full duty factor transmission 616 follows the time break 615. The operations will now be described in further detail. As shown in FIG. 6A, the first event is the CAC period 613, which is performed by the radar detector on the radio's transmit channel. Once the CAC period 613 finishes, the links lock up. Until there is a reverse communication link, there is no information that can be communicated between them. So until that point in time, any CAC 613 or in-service monitoring 614 is performed locally because there would be no way to relay that information from the other side if it were performed remotely. To accomplish the local in-service monitoring the radar detector listens at the transmit frequency. Therefore, the transmitter cannot transmit all the time or the radar detection receiver is swamped. The transmitter is operated at a low duty factor during this bootstrap period to facilitate the radar detection during this period. Once the round trip connection is made, the radar detector is switched to the receive frequency and used as a remote radar detector for the opposite side. The reverse of this happens on the other side, so that radar detection is performed at the respective receivers of both devices. FIG. 6A shows the operation of the transmitter where the high level of the pulses 14 and 16 indicate the on-time of the transmission. The break in timing shown by the double lines 15 indicates there is no specific time duration of these steps because that depends on the implementation.

As shown in FIG. 6B, during the CAC period 613, the radar detector listens for radars. During the off cycles of the low duty factor transmission, the radar detector listens on the transmit channel for radars. When the transmitter operates at full duty factor, it is no longer listening on the same channel and switches to the receive channel for the transceiver it is co-located with. The high level of the pulses 617, 618 and 616b, indicate the active listening time of the radar detector that is co-located in the same radio as the transmitter shown in FIG. 6A. During the CAC period 613, the transmitter is off, and the radar detector is listening for radars 617 on the transmitter channel. After the CAC period 613 passes, the transmitter begins transmitting at a low duty factor 614 while the radar detector still listens on the transmitter frequency channel during the off period of the transmitter duty cycle 618. After there is a round trip connection, the transmitter operates at a high duty factor 616, which can be as high as 100%, and the radar detector operates at a high duty factor but at the channel of the receiver in the radio housing.

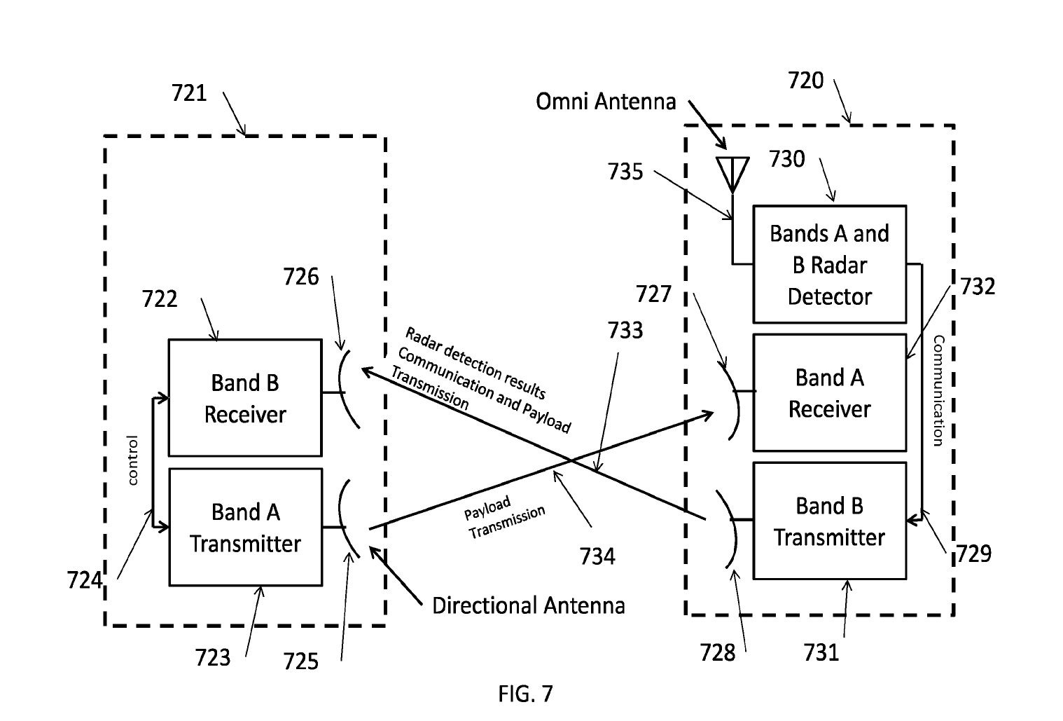

FIG. 7 shows a one-sided radar detection setup, which has a transmitter and receiver on one side, and a transmitter, receiver and radar detector on the other side. The radar detector relays its results through the communication means through its local transmitter to the receiver on the other side, as a notification that the transmitter on the other side must stop transmitting. The exemplary block diagram in FIG. 7 indicates an exemplary implementation corresponding to the embodiment shown in FIG. 4.

FIG. 7 shows a radio link between a first transceiver 720 and a second transceiver 721. The second transceiver 721 includes a Band B receiver 722 and a Band A transmitter 723 in communication with one another over communications link 724. The Band A transmitter includes 723 includes a directional antenna 725, and the Band B receiver includes a directional antenna 726. The first transceiver 720 includes a Band A receiver 732 having a directional antenna 727 and a Band B transmitter 731 having a directional antenna 728. The first transceiver 720 further includes a Bands A and B Radar detector 730 having an omni-directional antenna 735. The Bands A and B Radar detector 730 is in communication with the Band B transmitter over link 729. The normal payload transmission traffic between transceivers 720 and 721 occurs over communications link 734 in the reverse direction on Band A and is transmitted by the Band A transmitter 723 and received by the Band A receiver 732.

In FIG. 7, the interaction between the Bands A and B radar detector 730 and the transmitter 723 is shown as a communication to the local transmitter 729 and the communication 733 through the local transmitter 729 to the remote receiver 726 is the combination of the radar information and the radio payload on transmission Band B. In this case, the Bands A and B radar detector 730 first listens through the omnidirectional antenna 735 on Band B for the CAC and low duty factor transmission from the Band B transmitter 731 through the directional antenna 728. The Bands A and B radar detector 730 signals through communication link 729 if the channel is clear or blocked. After bootstrap, the Bands A and B radar detector 730 switches its listening frequency to Band A and performs in-service monitoring for Band A transmitter 723. If the Bands A and B radar detector 730 detects a radar, it signals through communication link 729 to the Band B transmitter 731, and then over the air on radar detection results Communication and Payload Transmission 733 to radio 721. The radar detection results are received by the Band B receiver 722 through antenna 726. The Band B receiver 722 sends control information over link 724 to indicate to the Band A transmitter 723 that transmission needs to stop. The radio 721 then selects an alternate operating frequency if one is available.

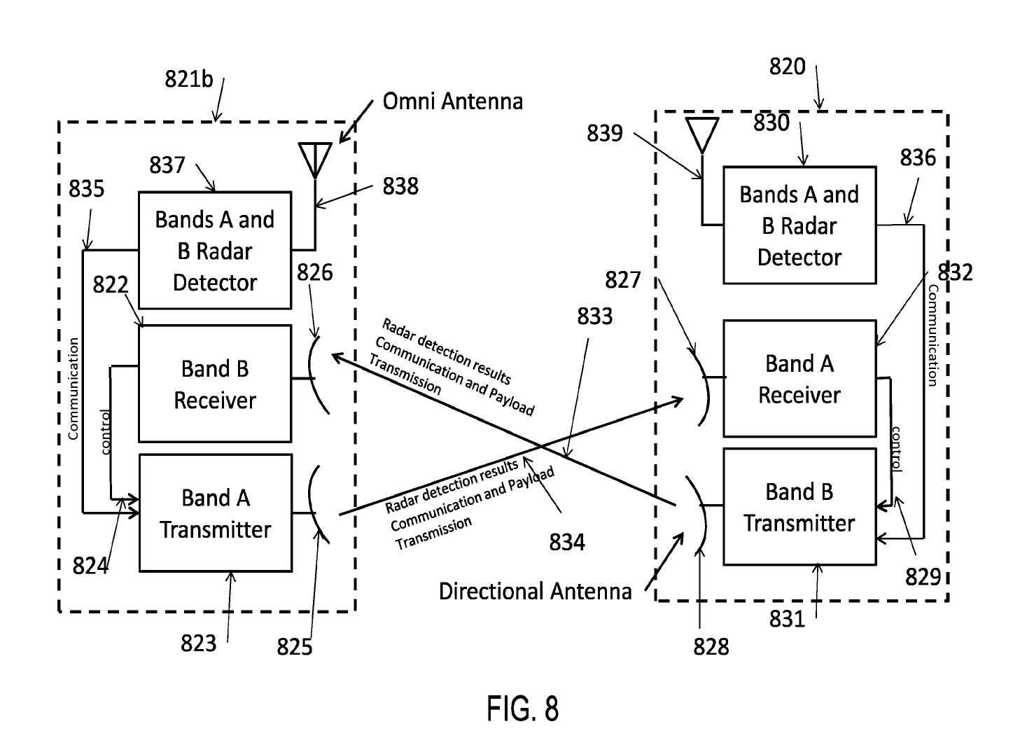

FIG. 8 shows a two-way link, which has a transceiver and radar detector on both sides of the link. The radar detector on each side of the link uses its local communication links to either enable/disable its local transmitter after CAC and during bootstrap, or to communicate to the other side of the link to indicate to the other side that the transmitter has a clear channel or must stop transmitting due to a radar on its channel.

In particular, as shown in FIG. 8, the two-way link includes a first transceiver 820 and a second transceiver 821. The second transceiver 821 includes a Band B receiver 822 and a Band A transmitter 823 in communication with one another over communications link 824. The Band A transmitter includes 823 includes a directional antenna 825, and the Band B receiver includes a directional antenna 826. The second transceiver 821 further includes a Bands A and B Radar Detector 837 and an omni-directional antenna 838. A communications link 835 is provided between the Bands A and B Radar detector 837 and the Band A transmitter 823. The first transceiver 820 includes a Band A receiver 832 having a directional antenna 827 and a Band B transmitter 831 having a directional antenna 828. A communications link 829 is provided between the Band A receiver 832 and the Band B transmitter 831. The first transceiver 820 further includes a Bands A and B Radar detector 830 and an omni-directional antenna 839. The Bands A and B Radar detector 830 is in communication with the Band B transmitter over link 836. The normal payload transmission traffic between transceivers 820 and 821 occurs over link 834 in the reverse direction on Band A and is transmitted by the Band A transmitter 823 and received by the Band A receiver 832.

An exemplary sequence can be that each side listens in its respective transmit band, Band A for radio 821b and Band B for radio 820, during the respective CAC periods 17. After each radio passes CAC, the transmitter on one side, for example Band A transmitter 823, starts transmitting at low duty factor, and the Band A and B radar detector 837 performs in-service monitoring. After the Band A receiver 832 locks to the Band A transmitter 823, there is a reverse link transmission that locks the Band B transmitter 831 to the Band B receiver 822. Then, the Band A and B radar detectors 837 and 830 switch from their respective transmit bands to their respective receive bands, the Bands A and B Radar Detector 830 listens on Band A to monitor for radars in the channel of the Band A transmitter 823 and the Bands A and B Radar Detector 837 listens on Band B to monitor for radars in the channel of the Band B transmitter 831.

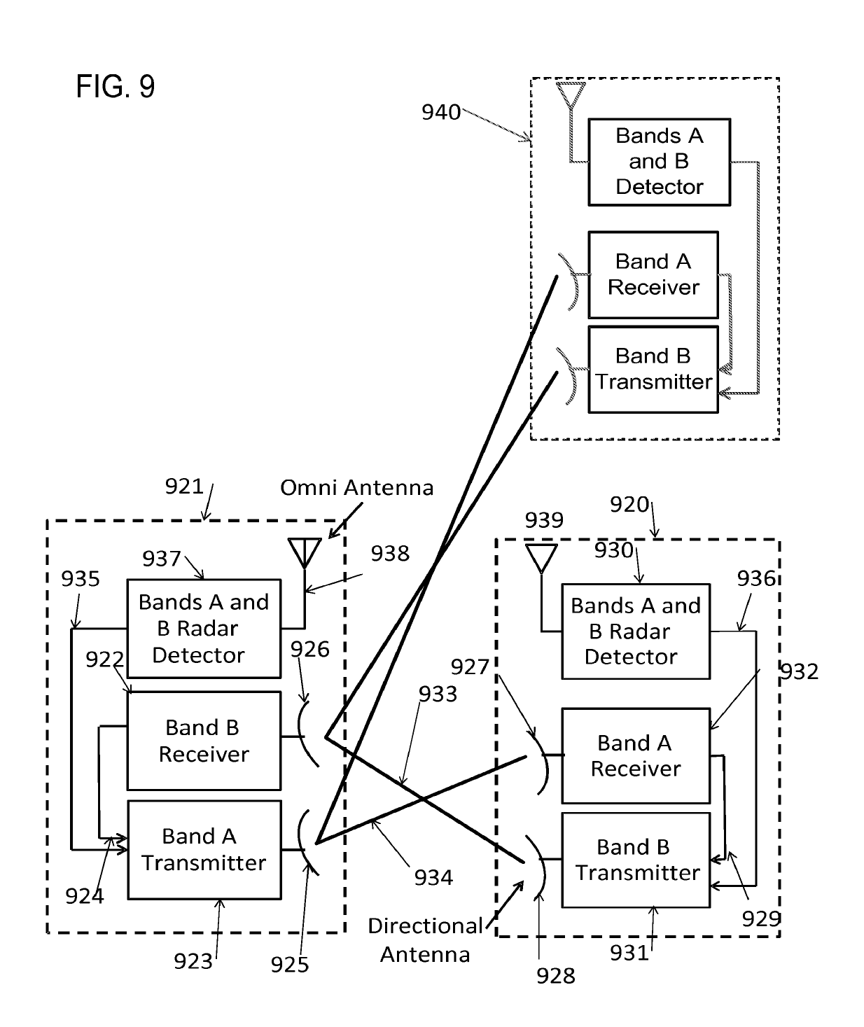

FIG. 9 shows that the same approach is scalable to a point-to-multipoint network. It will be appreciated that the approach is also scalable to multiple point-to-point, ad hoc, ring, self-organizing, relay, mesh and other network architectures. It will be appreciated that the approach may be used with any connectivity architecture.

In FIG. 9, a third transceiver 939 is part of the network (or system). The third transceiver 939 is shown in FIG. 9 directly connected to transceiver 921. It will be appreciated that the third transceiver 939 could alternatively be directly connected to transceiver 920. In one exemplary embodiment, the transceiver 921 is a multipoint aggregator and transceivers 920 and 939 are multipoint remote units. In this case, each of the remote transceivers 920, 939 performs its own CAC on its respective transmit bands. After locking to the multipoint aggregator 921, the transceivers 920, 939 switch their Band A and B radar detectors to their receive bands to do in-service monitoring in the Band A Transmitter transmit band. If a radar is detected in one of the remote radios 920, 939, the aggregation radio 921 is informed through the communications link and it stops transmitting on that channel. A new channel is determined for both remote transceivers 920, 939. It will be appreciated that the results of individual radar detectors may be communicated to the other radios (not shown) in a sub-net or area wide network.

In the point-to-multipoint configuration of FIG. 9, the radar detection task is distributed among the remote transceivers 920, 939 such that they perform detection on different parts of the radar detection band or the useable bandwidth, each detecting on a portion of the bandwidth of interest, and including but not limited to one detecting on the operating channel while the other detects on an alternate channel that can be used as a hot spare to jump to in the event the operating channel must be vacated. The radar detectors in the radio system become a shared resource or network of radar detectors tied together through a communications systems, where the detectors are used cooperatively, or in a coordinated manor, to perform in-service monitoring, channel look ahead, extended detection bandwidth, and more reliable detectability through location, angle, and antenna diversity. In an exemplary embodiment, one remote radio detects on part of the channel bandwidth and the other remote radio detects on the remaining part. With more radar detectors, the load can be divided appropriately. In another exemplary embodiment, one remote radio performs radar detection on an assigned portion of the band or sub-band where the operating channel is, and at least one other radar detector in a different location performs radar detection in another portion of the band or sub-band, which is then available immediately if the operating channel has to be vacated. In one exemplary embodiment the distribution of detection bandwidth, operating bands, or sub-bands is determined early in the bootstrap period, and, in another exemplary embodiment, it is dynamically determined once the radio locks up and enters in-service monitoring. These radar detectors communicate their results back to the multipoint aggregator 921, or to each other in other configurations of the intercommunication. In a further exemplary embodiment, the aggregator 921 also has a radar detector co-located with the transmitter that can operate in the band or sub-band but sufficiently spaced from the operating channel that it is protected from the transmission and can perform radar detection on these well-separated channels to provide alternate channel availability for the transmitter.

To compensate for the asymmetry in detectability versus interference an embodiment of the present invention is a radar detection apparatus with high antenna gain in all directions of potential angle of arrival that the radar signals should be detected. An embodiment of the invention is a radar detection apparatus that has high antenna gain in every required direction in azimuth and/or across various elevations simultaneously to provide reliable detection of a wideband radar signal at long range.

As background, it must be understood that detection of a radar signal is determined when measurements are made of the signals in the channel and it appears that there exists a signal characterized by certain specifications provided by a regulatory agency (e.g. the FCC) that the radar is present at an amplitude of concern. The characteristics specified for the measurement is usually for several combinations of radar pulse width and radar pulse repetition, and for a signal that has crossed a threshold of receive power level at the RF plane of the detector antenna (the RF plane is the imaginary plane at the location of the physical interface of the antenna and the air, and normal to the direction of a test signal generator that is used to guarantee the detectability is met).

An example of a radar waveform that is required to be detected at the RF plane of the detector under the FCC regulations would be a pulse width=1 microsecond, receive power>−64 dBm, and pulse repetition interval=1428 milliseconds for 18 repetitions. The detectability of such a signal can be verified in a test laboratory.

Reliable detection of the radar pulses can be inhibited by noise and interference. It is understood in the known art of detection theory that when a signal is contaminated with noise and interference detection becomes probabilistic, and there is a tradeoff of the probability of detection versus the probability of false detection (also known as, false alarm). When the signal is not present, there is just the noise and interference. If the parameters of the sum of noise and interference cross the threshold or otherwise show the characteristics that the detector is looking for a false detection can occur. The cost of a false detection is that the radio would have to vacate a channel unnecessarily. In many regulatory environments, the channel is required to be vacated for 30 minutes after radar detection occurs. Conversely, if the required receive power is raised so that fewer false detections are encountered, more actual pulses may be missed resulting in missed detections. However, if the required receive power is lowered so that more radar signals can be detected, it is possible to incur more false detections.

If the radar signal is present above the specified detection receive power threshold level, then the possibility exists that the radio associated with the radar detector might interfere with the radar receive signal.

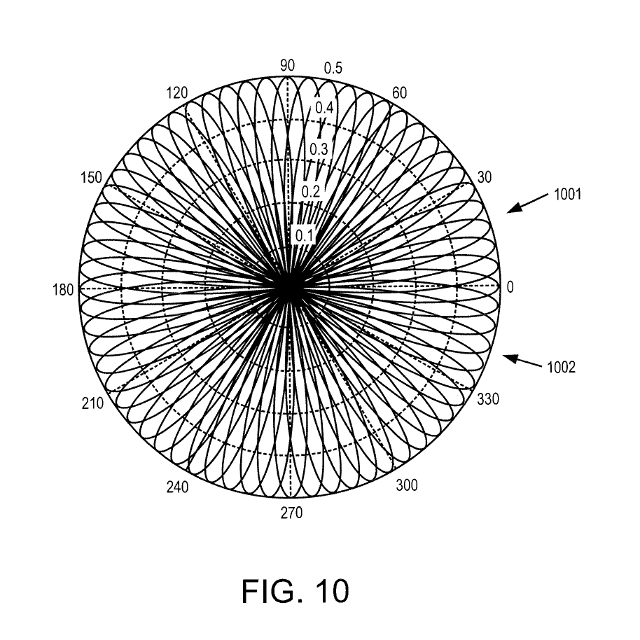

Applying high gain in every direction of interest as described in the instant invention solves the signal to noise problem with detecting a wideband radar at a low level, so that it can be detected near the radio before the radio can interfere with the radar. It is complex to performing such an RF and signal processing task. A multi-beam antenna must be made where each beam has very high receive antenna gain, yet passes the entire search bandwidth. The search bandwidth is the bandwidth that the detector must observe to determine the presence of a radar. A radar signal may have a bandwidth of only 1 MHz, but the center frequency may not be known within a 50 MHz span. Therefore all 50 MHz must be searched for the 1 MHz pulse. It is possible to break up a wider search bandwidth into multiple instantiations of the apparatus explained below in FIGS. 10-15. In that case, the sample rate and bandwidth of the circuits will define the bandwidth of each instantiation, and the local oscillator 1015 will convert the appropriate section of the overall bandwidth into the search bandwidth of its instantiation.

FIG. 10 shows the beam patterns 1001 of the multi-beam antenna system of an exemplary embodiment of the instant invention for a radar detector. The looping lines 1002 that extend from the center are indicative of antenna gain as a function of angle that will raise the received signal above the input LNA (low noise amplifier) noise floor for each radar detection circuit in the radar detector. The circular array is just one possible implementation. Another exemplary embodiment is a multi-sided array that is planar or occupies an arc in antenna placement on each side. If it is required to detect from all directions, a four-sided planar array can be weighted to provide a full azimuth view. The planar array can have more than four facets. It can be a polygon that has views compensated in the directions of the corners. Another embodiment of the invention is to print dipoles or other antenna types as an array on a flexible circuit board and formed into a circular antenna array or a partial circular array. The circular array may also be comprised of concentric circles of antenna arrays.

Another embodiment of the present invention is to use antenna elements that have some antenna gain and look over a subset of the azimuth or elevation direction. To the extent that the fields of the multiple antennas of this type overlap, the signals are combined to create multiple antenna beams in that direction, each with higher gain in order to overcome the said asymmetry in the detectability of the radar signal versus the interference of the radio impinging on the radar. Taken together, these multiple beams provide higher gain coverage of the required angle of radar signal incidence monitoring than the individual antennas, yet simultaneously each beam is monitored for detection. Examples of such directional antenna elements include reflected dipoles and patch radiators, as well as other antenna element types, such as described in commonly assigned U.S. patent application Ser. No. 14/837,797, filed Aug. 26, 2015, U.S. Pat. No. 9,178,558, U.S. Pat. No. 9,001,809, U.S. Pat. No. 8,824,442 and U.S. Pat. No. 8,467,363, and commonly assigned U.S. patent application Ser. No. 14/559,859, filed Dec. 3, 2014, U.S. Pat. No. 8,872,715 and U.S. Pat. No. 8,928,542, the disclosures of all of which are hereby incorporated herein by reference in their entirety.

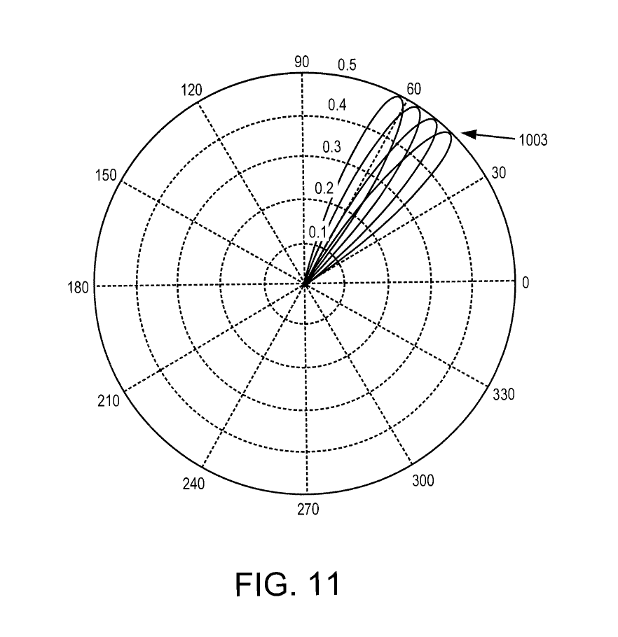

FIG. 11 shows an exemplary radar detector beam pattern 1003 with the beams confined to one direction in order to verify a detection or to limit the detection angle. It is not required that the beams form a contiguous section of azimuth or elevation. Gaps in the detection angle can be covered in a time multiplex fashion where one set of antenna beams is used and then another is used. Thus all the receiver and detection hardware is time-shared.

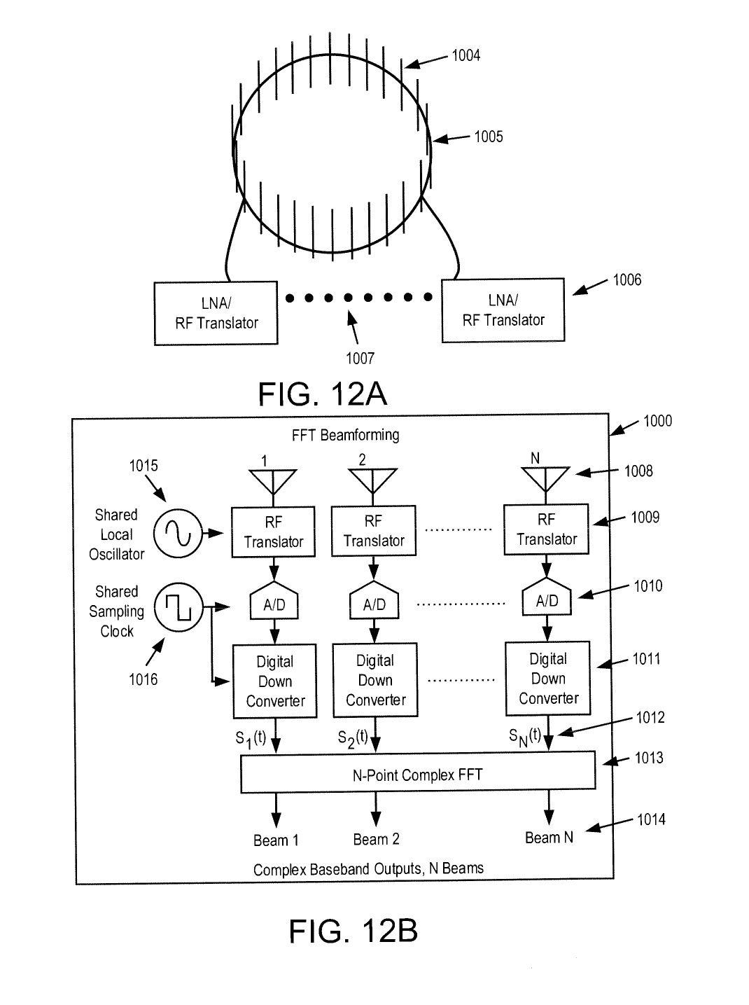

FIG. 12A schematically shows an exemplary embodiment of the antenna array apparatus where a circular array of dipoles 1004 is used. The dipole antennas 1004 are mounted on a ring 1005. Each antenna is schematically shown as passing its receive signal to a low noise amplifier (LNA) and an RF translator 1006. The ellipse punctuation 1007 in between the LNA/RF Translators indicates schematically that each of the dipole antenna elements is coupled to or couplable to a receive chain as also shown in FIG. 12B. In further explanation, it will be clear from the context that each antenna element, group of elements, or antenna structure that is labeled as having a signal path, will comprise a receive chain and the ellipse will be not be notated. This is an exemplary embodiment and it is noted that different approaches to capturing the signal from each antenna for beamforming of multiple simultaneous beams satisfy the limitation of the present invention provided they are used to raise the SNR of the received radar signal at the input of the radar detector, including antenna elements that each have antenna gain, or are each a directional antenna array comprising a plurality of directional antenna sub-arrays and/or a plurality of directional antenna elements, but with overlapping collecting angles.

FIG. 12B shows a block diagram of an exemplary embodiment 1000 of the receive processing of the signal. There are different ways to approach the downconversion and sampling and the embodiment is not meant to exclude different approaches to do this that are well known in the existing art, including such as those described in U.S. patent application Ser. No. 14/988,578, U.S. Pat. No. 9,055,463, U.S. Pat. No. 8,811,365, U.S. Pat. No. 8,311,023 and U.S. Pat. No. 8,238,318, the disclosures of which are hereby incorporated herein by reference in their entirety. In the case of the exemplary embodiment in FIG. 12B, the signal received from each antenna 1008 is amplified and downconverted through the RF translator stage 1009 which also receives a shared local oscillator 1015 as an input in order to facilitate the downconversion. The downconversion can translate the input signal to baseband or to an IF frequency for IF sampling or filtering and further downconversion. In each signal chain, the signal then passes through a sampling stage where it is sampled with a sampling clock 1016, and converted to a digital signal in an A/D (analog to digital) converter 1010. Each signal may then be further processed with digital downconversion 1011 comprising down-sampling. For example, the A/D convertors can be sigma-delta convertors. Digital down-sampling often comprises half-band filtering and may comprise digital filtering to get to the final resolution bandwidth of the effective sample rate and number of resolution bits in each of the signals S(t) 1012 that will be processed by the N-point complex FFT 1013. The FFT operates on the set of samples that occur approximately simultaneously from each antenna input such that an FFT operation occurs for each time sample across the digitally sampled antenna inputs. The output of the N-point complex FFT 1014 is an antenna beam per FFT bin. Note that it is implied that there can be many such receive chains, even though there is no ellipse between beam 2 and beam N.

The series of outputs of each FFT bin 1014 is a sample stream at the bandwidth that is being searched. Therefore there will be N such streams, with each stream having the radar search bandwidth. The N-point complex FFT 1013 may be pipelined such that a complete N-point complex FFT is performed for each sample of the full bandwidth.

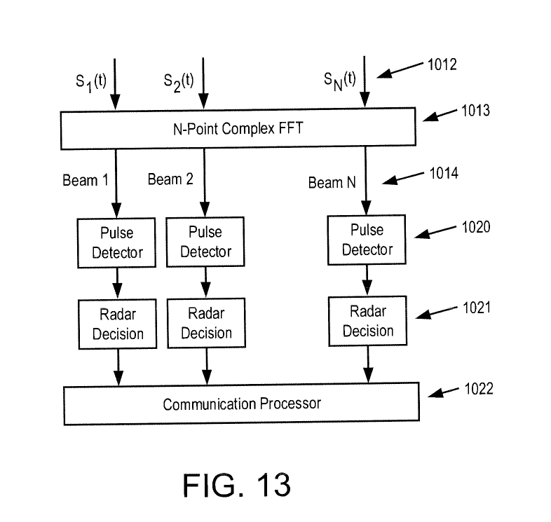

As seen in FIG. 13, which for clarity repeats the N-Point Complex FFT 1013 and its inputs 1012 and outputs 1014, each full-output-bandwidth signal at the output of each FFT bin 1014, is fed to a pulse detection subsystem that comprises pulse width and pulse repetition identification such that a radar can be detected in any of the beams formed by the N-point complex FFT bins. The output bins of the N-Point Complex FFT 1013 that form the full bandwidth beams 1014 are then processed to search for radar pulses. Each beam 1014 passes through a pulse detector 1020 that searches for signals with a pulse width that falls within the specifications as previously discussed, and the repetition pattern of the pulses are examined in the radar decision stage 1021 to determine if there is a combination of pulse width and pulse repetition interval that satisfies the requirements to determine one of the radar types of interest has appeared in one or more beams. The results are passed to the operational radio through the communications processor 1022. This result may be combined with results from other radar detectors of this or another type to create an aggregate result. It will be appreciated that the FFT, pulse detector, radar decision stage, and communications processor, can be instantiated in either hardware, software operating on a processor, or a combination as satisfies the requirements for the tradeoffs of bandwidth, power consumption, duty factor and other system level constraints that are well understood. The angle of arrival of the radar signal is determined from the FFT bin or bins that the signal is detected in.

Another exemplary embodiment uses phase shifts of the input antenna signals in different input bins of the FFT to create beams that fill in between the un-shifted beams at the FFT outputs such that the sum of the shifted and un-shifted results overlap to fill in the gaps in coverage between the beams of either. Other methods for this purpose include oversampling the FFT. Phase shifting at the input of the N-Point Complex FFT 1012 may also be performed in the RF section 1009, or the digital sampling 1011, or by shifting the local oscillator 1015 or sampling clock 1016 across inputs, to generate beams confined to limited angles as in 1003.

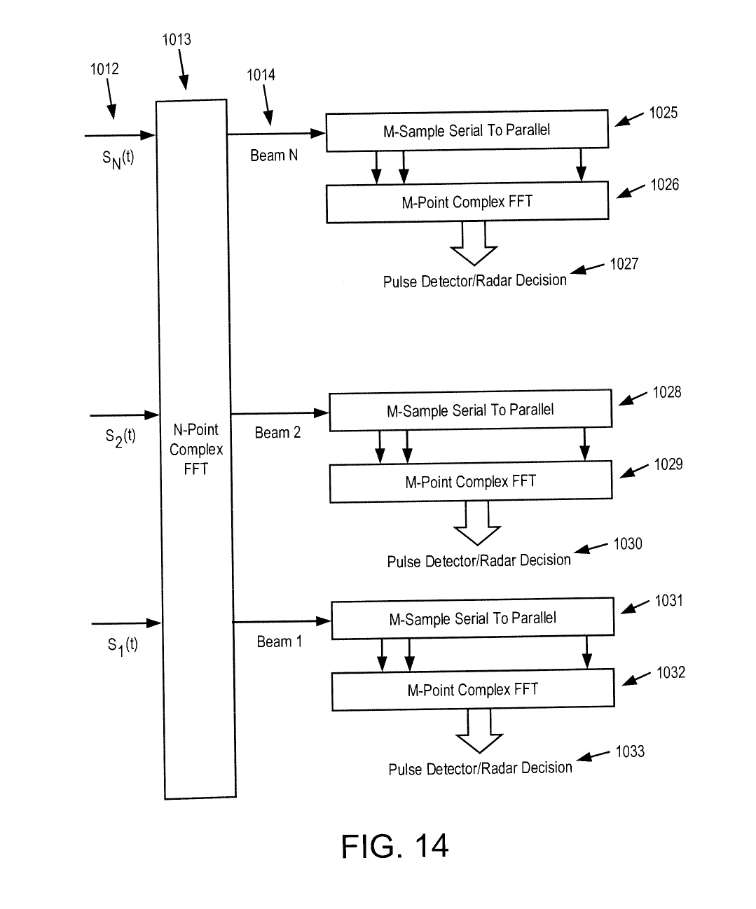

The pulse detector in FIG. 13 can itself be an FFT that operates on the sequence of samples in each beam (i.e. one FFT per beam) that appear after each spatial FFT, in which case the samples would be gathered up for the appropriate resolution that would be required within the bandwidth that the samples represent. FIG. 14 shows one exemplary embodiment of this configuration, where the N-Point Complex FFT 1013 from FIGS. 3 and 4, with its inputs 1012 and outputs 1014, are moved into a buffer, which as an exemplary embodiment can be a serial to parallel convertor 1025 at a sample rate the full search bandwidth. The M-sample Serial to Parallel buffer 1025 stores a sequence of outputs for the beam 1014 it is receiving samples from, and those samples are passed through an M-Point Complex FFT 1026, where M of 1026 and N of 1013 are chosen independently. The M-Point Complex FFT is a means to separate the search bandwidth into filtered bins, where pulses in each bin have higher SNR than if they were unfiltered, and so the FFT 1026 provides a parallel bank of filters. A radar pulse can appear in one bin or across multiple bins, depending on its bandwidth and the value of M. The output of the M-Point Complex FFT 1026 is passed to a pulse detector and radar decision apparatus 1027 to determine the presence of a radar. By extension, each of N outputs is similarly processed in serial to parallel convertors e.g. 1028, 1031, M-Point Complex FFTs e.g. 1029,1032, and pulse detector/radar decision apparatus e.g. 1030, 1033.

The M-sample serial to parallel may also comprise multiple multiplexed or pipelined storage elements so that the M-point Complex FFT can be calculated while the samples for the next FFT are being stored. FFT processing may also be ping ponged so the FFT can take longer for processing.

It is appreciated that the FFTs can be real FFTs instead of complex FFTs, and that quasi-coherent or non-coherent processing can be performed as an embodiment of the present invention. It is also appreciated that other computations may be performed besides an FFT in each of the N-Point and/or M-Point FFT, including a DFT, a chirp transform, or a modified transform that provides a variation on spatial processing, as an embodiment of the present invention. The specific processing described is meant to teach the invention in terms that will be readily understood and practiced by those of ordinary skill in the art, and with sufficient detail that the invention of increasing the detectability of a radar signal with wide bandwidth and low signal level while examining over a broad direction is achieved.

Another embodiment of the invention is that the multiple beams are created with either beamforming phase and amplitude modification elements or with a FFT processor performing a spatial Fourier transform.

Another embodiment of the invention is that each output bin of the FFT or other multi-beam processing in the exemplary radar detector is passed to a radar detection circuit so that multiple radar detection circuits are operating, each processing a signal received with high antenna gain in each of the intended directions.

Another embodiment of the invention is that the exemplary radar detector may be remotely located from the radio and have a communication mechanism to the radio, either wired or wireless. The detection results processed from any of the radar detection beam outputs can be combined in communicating the results to the radio.

Another embodiment of the invention is that the exemplary radar can be directed to a subset of the entire azimuth and elevation direction to detect a radar in the direction of a directional antenna that the radio uses to protect the radar from the radio interference.

Another embodiment of the invention is that beams created by the set or a subset of antennas are directed to a subset of the entire azimuth and elevation direction to concentrate antenna gain from one or more beams in the direction of a suspected radar, which may be suspected due to an earlier detection, in order to verify the presence of the radar with higher signal to noise ratio.

Another embodiment of the invention is that the task of examining angles of elevation, azimuth and sampling over time, may be distributed among more than one radar detector operating in parallel, in different locations, and the results taken individually or combined.

The Out of Band Emissions (or OOBE) specification for a particular operating band is intended to keep the adjacent and nearby bands clean of RF energy splatter for potential victim users operating in those bands. There is generally no way to know a priori where the protected equipment is located or when it will be operating, resulting in protection of the victim's bands that is overreaching and wasteful of spectrum.

One embodiment that addresses this fundamental problem uses a victim-signal detector that detects energy that is not normally within the operating band to determine the presence of the signal from a device that would fall victim to certain levels of OOBE. If the victim device signal is present (or above a victim-signal threshold level), this detector enables placement of limits on various parameters of the operating channel radio transmission; yet, if not present, this detector enables relief of such limits on the operating channel radio transmission. These limits upon the operating channel radio transmission can be expressed in the form of a set of operational parameters including at least the following:

1) Adjustment of a transmit power level at the operating transmitter such that the OOBE will not unacceptably interfere with the victim, at the expense of limiting the range and/or potential data rate throughput performance for the operating transmitter. The degree to which a transmit power level must be lowered or can be raised can also be a function of the victim's actual detected signal level and/or other range or location information. Alternatively or in addition to the above, the operating transmitter if used in conjunction with an antenna array may steer the operating channel radio transmission in a different direction or create a transmit EIRP null in the direction towards the victim so as to also keep OOBE from unacceptably interfering with the victim.

2) Changing one or more frequency channels of the operating transmitter such that a particular frequency channel is separated enough in the frequency domain from victim-signal detection frequency so that the OOBE will have enough transition bandwidth and thus will not unacceptably interfere with the victim, at the expense of limiting the range and/or potential data rate throughput performance for the operating transmitter. The degree to which a particular frequency channel of the operating transmitter must be moved further from or can be moved closer to in the frequency domain to the victim's RF signal frequency can also be a function of the victim's actual detected signal level and/or other range or location information.

3) Modifying a channel filtering parameter of the operating channel radio transmission which may include pulse shaping, windowing, baseband, IF (intermediate frequency), or RF filtering to keep OOBE from unacceptably interfering with the victim, at the expense of limiting the range and/or potential data rate throughput performance for the operating transmitter. The degree to which a channel filtering parameter of the operating transmitter must be increased or can be decreased in terms of the sharpness of the filter roll-off can also be a function of the victim's actual detected signal level and/or other range or location information.

4) Modifying an operating channel bandwidth so that the roll-off of OOBE is sharper in the frequency domain so as to keep OOBE from unacceptably interfering with the victim, at the expense of limiting the range and/or potential data rate throughput performance for the operating transmitter. The degree to which an operating channel bandwidth of the operating transmitter must be decreased or can be increased can also be a function of the victim's actual detected signal level and/or other range or location information.

5) Changing a permissible transmit duty cycle of the operating transmitter to keep OOBE from unacceptably interfering with the victim, at the expense of limiting the range and/or potential data rate throughput performance for the operating transmitter. The degree to which a transmit duty cycle of the operating transmitter must be decreased or can be increased can also be a function of the victim's actual detected signal level and/or other range or location information.

6) Any combination of 1, 2, 3, 4 and 5 above.

Methods for sharing a channel with radars as primary users have been known for some time and is codified in the regulations of many nations. Radar detection has been used to allow sharing of the spectrum with radar equipment, which has unpredictable usage and location. The method for radar detection is known as dynamic frequency selection (DFS) in most regulatory regions. For DFS, there are a number of different radar waveforms that are described in the regulatory documents. The description of the radar is often based on pulse width and pulse interval. Conformance tests are described whereby the operating transmitter cannot emit its operating signal until it has verified that none of the radar signals can be detected for a period time, e.g. 60 seconds. After the channel is determined to be clear, it is continually monitored to determine if a radar appears. If it does, the channel is abandoned for 30 minutes, and rechecked before attempting to transmit on that channel again.

Methods for sharing a channel with other users of the same status have also been known for some time and is codified in the regulations of many nations. Techniques known as “listen before talk” or “Clear Channel Assessment”, or “Carrier Sense”, are used for very rapid handing off of the use of the channel. These operate similar to a polite human conversation in that each user listens with a receiver to see if another user is already occupying the channel, and only if it is not occupied, may it transmit. The types of codified detection that occur are either simple energy detection to determine if there is some signal there, or preamble detection where the beginning of another users transmission is detected and the header is read in order to determine how long that user will occupy the channel.

Exemplary embodiments described herein address problems that are different from either the DFS radar detection problem or the channel sharing problem solved by “clear channel assessment”. DFS or clear channel assessment use the detection of activity to determine if the transmitter can be enabled in the channel in which the detection is performed. Even if the detection is performed in a different channel than the transmitter is currently operating in, it is for the purpose of determining a new operating channel for its transmission. By contrast, the embodiments herein perform detection in a different channel or even band than that in which the operating transmitter will actually operate in, in order to determine the level of OOBE of the operating channel radio transmission that can be tolerated.

The detection of the victim transmit signal may be done using simple energy detection, detecting features of waveforms, or detecting levels of activity, or a combination of these. The goal is to determine what OOBE the operational transmitter may allow in the victim channels or band. As also described above, the operating transmitter may control the amount of OOBE by, for example, occupying specific channels in the operating band, changing the channel bandwidth, adjusting the transmit power, adjusting the transmit duty cycle and/or adjusting the transmit signal filtering. If there is no victim active in the victim frequency band within the geographic vicinity of the operational transmitter, more of the operational band may be utilized at a higher power, wider channels, 100% duty cycle and with signal distortion due to heavy filtering. If there is a victim active within the victim frequency band and within the geographic vicinity of the operational transmitter then the level and type of activity of the signals emitted from the victim transmitter are an indication of the RF propagation path between the victim and the operational transmitter. The propagation path indication provides an approximation of how much impact the OOBE of the operational transmitter will have on the victim receiver. The regulatory agencies can codify test procedures that allow for sufficient margin that is even better protection than is given now to the victim receiver.

In the existing regulations, a tradeoff is made where the OOBE spec is made quite low, resulting in an unnecessary burden on the operational transmitter equipment. But still, there will be some distance between the operational transmitter and the victim receiver that the victim will be affected. With a victim-signal detector, instead of pre-selecting a single OOBE level to apply to all distances to the victim, the allowed OOBE level can be dependent on what is received at the victim-signal detector from the victim transmitter. The proper amount of protection can be prescribed for that particular circumstance. If the operating transmitter is very near the victim, the victim can still be protected, even if it means shutting off the operational transmitter or moving the transmission to another band that is further separated in frequency. But if the operating transmitter is far from any victim, it should be allowed to emit a higher OOBE, which translates into having more spectrum available at higher transmit power and with lower filter impairments to the operating channel radio transmission.

The operating transmitter will also have an operating receiver for the exchanging information with one or more other radios, such as backhaul radios. The victim-signal detector that detects the presence of the victim transmitter can be part of the operating transmitter structure, part of the operating receiver structure, or a separate device associated with the operating transmitter in a way such that the results of the victim-signal detection can control the operating channel radio transmission parameters. Multiple victim-signal detection devices, whether integrated within the operating radios or otherwise, can also be used in one or more of these configurations in order to enhance the victim detection and information gathering capability.

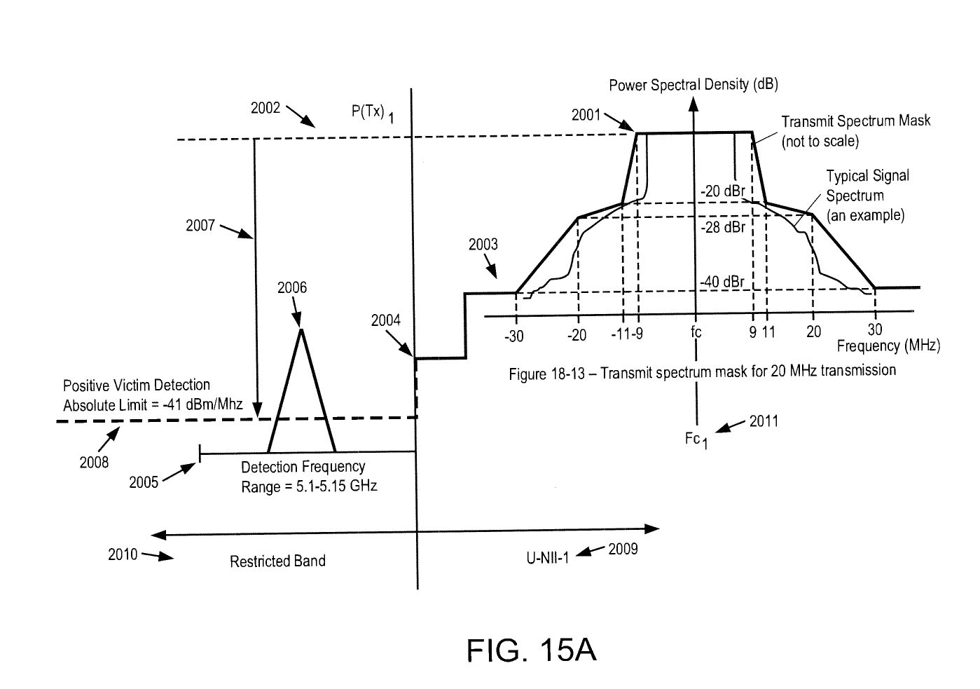

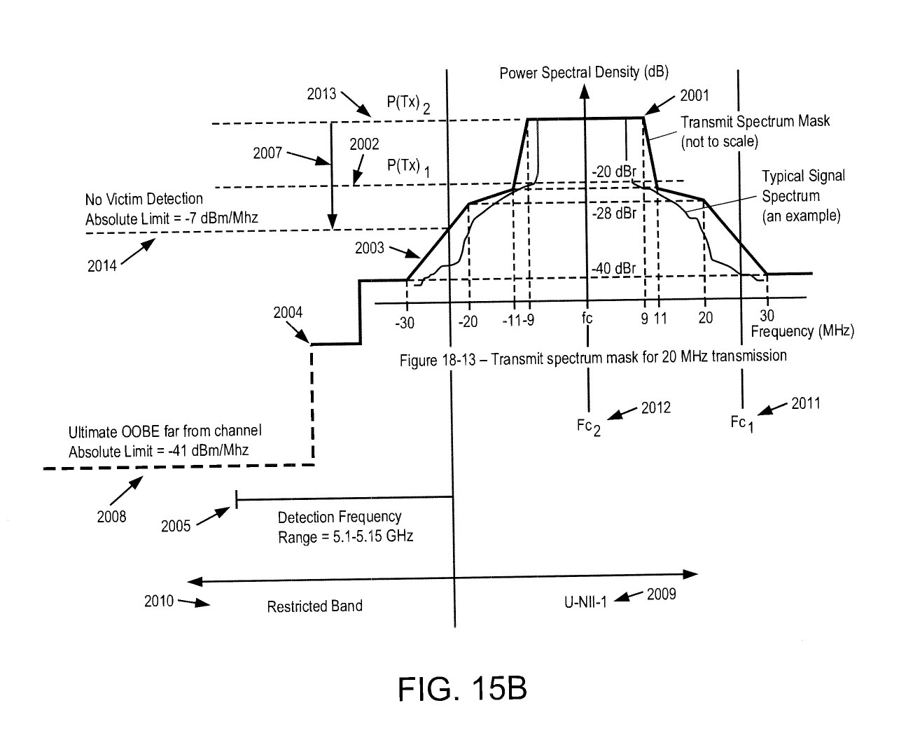

FIG. 15A shows an example of an operating band 2009, which is shown as the U-NII-1 band as an exemplary embodiment but can be any band, and an adjacent restricted band, which is also an exemplary embodiment, but can be any band impacted by the OOBE or out of channel emissions of transmit signal 2001. The spectrum of the transmit signal in the operating channel 2001 at power level P(Tx)1 is at the power spectral density of the dotted line 2002. The transition band 2003 of the spectrum ends at final cutoff frequency 2004, which achieves the specified absolute limit 2008 and extends through the detection frequency range 2005, which is an exemplary range of frequencies that the victim-signal detector can listen for victim transmitters. If a victim transmitter is detected at a specified level (or victim-signal threshold) then there must not be any OOBE from the operating channel radio transmission 2001 above the limit 2008. The difference in the levels 2007 between the transmit power spectral density 2002 and the limit 2008 is the amount of suppression required relative to the transmit power spectral density 2002. The suppression 2007 is a result of the natural rolloff of the pulse shaped transmit signal and additional filtering.

In the example in FIG. 15A victim transmitter 2006 is detected with the victim-signal detector which prevents using, for example, an operating frequency lower than Fc1 2011 and transmit power spectral density higher than 2002 or final cutoff frequency 2004 that would overlap the restricted band 2004 and violate the limit 2008.

In the example in FIG. 15B there is no victim transmitter detected and the transmit operating channel 2012 at lower center frequency Fc2 can be the operating channel, making better use of the spectrum. Similarly, the transmit power spectral density can be turned up to the dashed line representing transmit power spectral density 2013 which is higher than 2002. The final cutoff frequency 2004 is allowed to overlap the restricted band 2004 because the limit is moved up to new limit 2014 which is at a level 2007 that is lower than the new transmit power spectral density 2013.

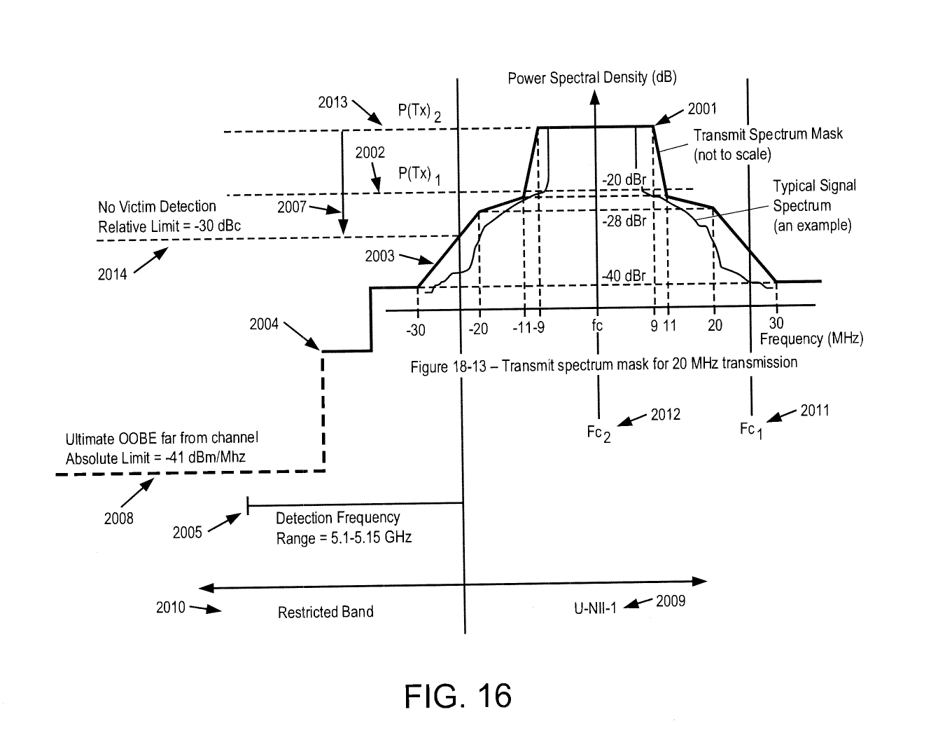

The same result as FIG. 15B is shown in FIG. 16, but the exemplary embodiment in FIG. 16 shows that the new limit 2014 is a relative limit instead of an absolute limit. The relative limit is with respect to the transmit operating channel power. While the drawing in FIGS. 15 and 16 show the U-NII-1 band and the OOBE detection occurring in the restricted band to lower frequency side, that is an exemplary embodiment only.

The embodiments described herein also work for spectra of concern that is within the operating band but outside of the operating channel as well as OOBE. Emissions that are outside of the channel but within the operating band are often referred to as out of channel emissions (OOCE).

The OOBE or OOCE detection can occur on either side of the operating band and can be used for any operating channel or bandwidth. As another exemplary embodiment, an operating channel radio transmission in the U-NII-3 band is restricted from emitting in the TDWR radar band 5600 MHz-5650 MHz. By detecting in the 5600-5650 MHz frequency range and determining if it is free from nearby radars, the OOBE limits for an operating channel radio transmission within the U-NII-3 band can be relieved and thus operation in the U-NII-3 band can use, for example, wider channels, channels closer to the U-NII-2C band edge, at higher power or transmit duty cycle, and/or with less restrictive filtering. Similarly, the U-NII-4 band to the upper side of the U-NII-3 band may be utilized by Wi-Fi or by the Intelligent Transportation System (ITS). By determining that there is no detectable signal, the OOBE limits for an operating channel radio transmission within the U-NII-3 band can be relieved, so that the channels near the upper end of the U-NII-3 band can be utilized, for example, at higher transmit EIRP and/or reduced filtering.

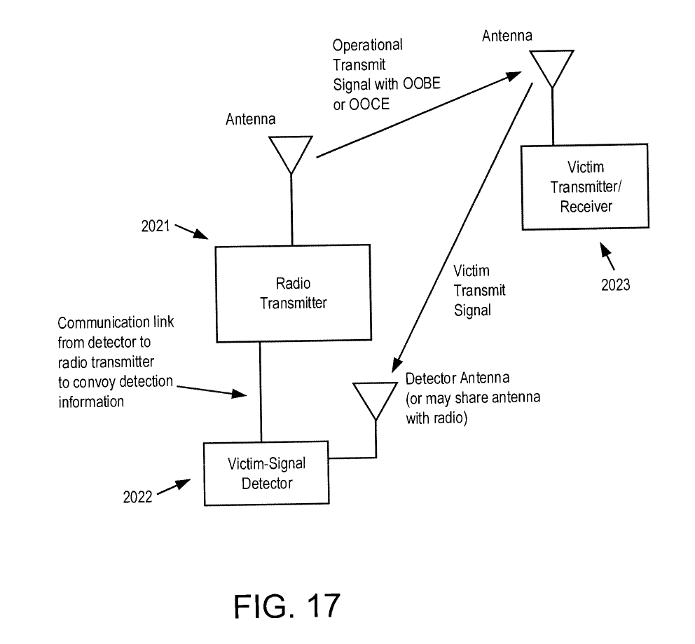

FIG. 17 illustrates an exemplary embodiment showing a radio 2021 that transmits in the operational band, a victim-signal detector for the victim's transmitted signal 2022, and a victim transmitter/receiver 2023. The victim can be any type of victim including another radio or a radar that operates outside of the operating band or channel range of interest of the radio operating transmitter 2021.

The OOBE or OOCE of radio operating transmitter 2021 in FIG. 17 could potentially interfere with a victim receiver. The victim-signal detector 2022 is connected (either by incorporation into its own circuits or through an external connection) to the radio operating transmitter 2021 such that the victim-signal detector 2022 can sense the presence of the victim 2023 in close enough proximity to operating transmitter 2021 such that the receiver of victim 2023 would be interfered with if there were high level OOBE or OOCE. The victim-signal detector 2022 communicates information about the measurements of the out of band or out of channel measurements to the radio operating transmitter 2021.

The sensing performed at the victim-signal detector can be as simple as an energy threshold detection depending upon the specific characteristics of the various candidate victim RF signals that may be expected to operate in the victim frequency band. In an exemplary embodiment, the detection process can be based on one or more values that represent characteristics or features or combinations thereof of the victim transmitter 2023, such as the pulse amplitude, timing, repeat rate of pulse repetition interval, channel impulse response from the transmission, difference in channel impulse response between different polarizations which would be used to indicate a property of the RF channel that is between the victim 2023 and the victim-signal detector 2022 (and also to estimate the channel between the victim 2023 and the radio 2021). The radio operating transmitter 2021 may use the detection result as a simple enable/disable or as information to perform other exemplary tasks such as change power, frequency channel, bandwidth of its transmission, duty factor of its transmission, or other characteristic of its transmission, as also described above. There may be a gradual tradeoff whereby a stronger or weaker signal from the victim 2023 translates into lower or higher OOBE allowed from the radio operating transmitter 2021. Detecting the type of victim 2023 that is in proximity may also affect the allowable OOBE. For example, a radar that has a very high gain antenna will be affected at longer range than a communications system which typically has much lower antenna gain, and subsequently, the threshold of victim detection level for a radar can be modified so that a victim radar drives the lower OOBE setting at a much lower received threshold level in the victim-signal detector 2022 than that of a victim communications system.

The victim-signal detector, although shown separate from the radio, may also be physically part of the same unit as the radio and may have its own antenna or may share one or more antennas with those used for transmit and/or receive by the radio. Exemplary antennas and/or antenna arrays suitable for either or both of the radio operating transmitter and/or receiver and/or the victim-signal detector are disclosed in commonly assigned U.S. patent application Ser. No. 14/837,797, filed Aug. 26, 2015, U.S. Pat. No. 9,178,558, U.S. Pat. No. 9,001,809, U.S. Pat. No. 8,824,442 and U.S. Pat. No. 8,467,363, and commonly assigned U.S. patent application Ser. No. 14/559,859, filed Dec. 3, 2014, U.S. Pat. No. 8,872,715 and U.S. Pat. No. 8,928,542, the disclosures of all of which are hereby incorporated herein by reference in their entirety. If the victim-signal detector is separated from the radio, the communications link may be wired or wireless, where the wired link may connect over a proprietary link or over the Internet. The wireless link may use a standard communications protocol or a proprietary protocol or may utilize an embedded control signal such as a spread spectrum signal or a pulsed communication signal. Exemplary embedded control signals suitable for such victim-signal detection embodiments are disclosed in U.S. patent application Ser. No. 14/983,059, filed Dec. 29, 2015, U.S. Pat. No. 9,252,857, U.S. Pat. No. 8,897,340 and U.S. Pat. No. 8,649,418, the disclosures of which are hereby incorporated herein by reference in their entirety.

Exemplary methods, apparatuses, systems and structures for implementing the radio operating transmitter as an RF signal transmitter are described herein and also in U.S. patent application Ser. No. 14/988,578, U.S. Pat. No. 9,055,463, U.S. Pat. No. 8,811,365, U.S. Pat. No. 8,311,023 and U.S. Pat. No. 8,238,318, and U.S. patent application Ser. No. 14/983,059, filed Dec. 29, 2015, U.S. Pat. No. 9,252,857, U.S. Pat. No. 8,897,340 and U.S. Pat. No. 8,649,418, the disclosures of all of which are hereby incorporated herein by reference in their entirety. For example, exemplary RF signal transmitters when used as operating transmitters may utilize power amplifiers (PAs), RF or IF filters, upconverters, vector modulators, baseband analog filters, digital to analog converters, digital filters, modulation mappers, and other such structures or methodologies as described herein or in the incorporated references or elsewhere as also apparent to one of skill in the art.

Exemplary methods, apparatuses, systems and structures for implementing the victim-signal detector as an RF signal receiver are described herein and also in U.S. patent application Ser. No. 14/988,578, U.S. Pat. No. 9,055,463, U.S. Pat. No. 8,811,365, U.S. Pat. No. 8,311,023 and U.S. Pat. No. 8,238,318, and U.S. patent application Ser. No. 14/983,059, filed Dec. 29, 2015, U.S. Pat. No. 9,252,857, U.S. Pat. No. 8,897,340 and U.S. Pat. No. 8,649,418, the disclosures of all of which are hereby incorporated herein by reference in their entirety. For example, exemplary RF signal receivers when used as victim-signal detectors may utilize LNAs, RF or IF filters, downconverters, vector demodulators, baseband analog filters, analog to digital converters, digital filters, FFTs, matched filters, and other such structures or methodologies as described herein or in the incorporated references or elsewhere as also apparent to one of skill in the art.

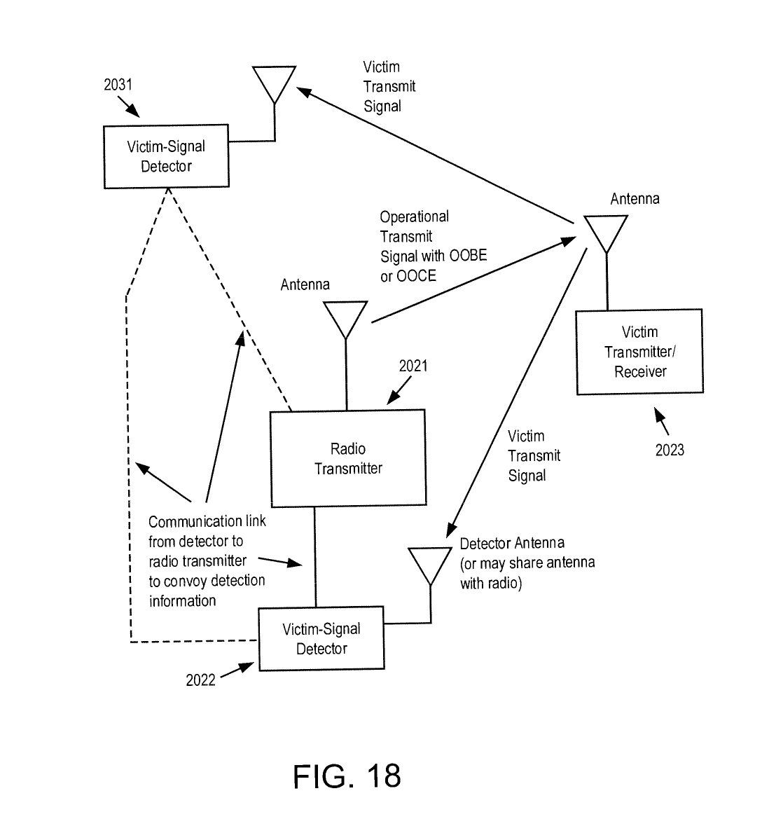

As shown in FIG. 18, more than one victim-signal detector 2022, 2031 may be used to provide additional information, which can be taken in aggregate to make a determination of parameters of the victim transmitter/receiver 2023. Two are shown in FIG. 18 but there is no limit to the number and many detectors may be used. The information may be aggregated within a single detector, or a separate detector/aggregator, or may be aggregated in chain-like fashion, or may each communicate to the radio operating transmitter 2021 through independent means or as a network. For example, each may have a Wi-Fi connection to a separate Wi-Fi hub in the radio operating transmitter 2021. The Wi-Fi hub could both transmit and receive and operate a network formed with the victim-signal detectors 2022, 2031, etc. that is independent of the operating transmitter that impinges on the victim transmitter/receiver 2023.

Another embodiment is for the detector 2022, 2031 to ascertain aspects of the victim transmitter/receiver 2023 that allow the coordination of the duty cycle or transmit time period, frequency channel and/or direction for the operating channel radio transmission of the operating transmitter 2021. In one embodiment, multiple detectors, e.g. 2022 and 2031, can combine information and use time-difference-of-arrival or diversity views of signal level of the signal from the victim transmitter 2023 to determine the location or angle between the radio operating transmitter 2021 and the victim transmitter/receiver 2023. The radio operating transmitter 2021 can use this information to perform adaptive nulling its signal or simply a reduction in antenna gain of its signal in the direction of the victim transmitter/receiver 2023.

In another embodiment, the signal detector(s) 2022, 2031, etc. determine a periodicity of the victim transmit signal (which may be indicative, for example, of a rotating radar antenna), and convey that information in a form the radio operating transmitter 2021 can use to time its operational transmissions such that it is only emitting higher levels of OOBE or OOCE when the victim receiver 2023 is not in use or at least not in use in a direction in which the operating transmitter OOBE or OOCE unacceptably interferes with the victim. The time of arrival of the radar pulse may be derived from relative timing that is synchronized between the signal detector(s) 2022, 2031, etc., and the radio operating transmitter 2021, or absolute time may be conveyed to the equipment over the network, such as the Network Time Protocol (NTP), or through the use of the Global Positioning Satellite system (GPS).

In another embodiment, the signal detector(s) 2022, 2031, etc., may track the time and level of a victim transmitter 2023 signal to ascertain the beam location and/or closing speed of Earth Exploration Satellite Service (EESS) radars as a victim 2023. These radars move along the earth in a steady and predictable pattern. The invention would allow victim-signal detectors to observe the radar beam moving across the earth, communicate among one another to determine the victim radar path and alert other victim-signal detectors that are in its path so that they can have improved detection reliability of these. The signal detection and reaction to these victim transmitters 2023 is based on more stable information that is determined over more than one victim-signal detector and for a longer period of time.

As described above, in some embodiments the operating transmitter and the victim-signal detector may share the same common antenna or directional antenna array. For operating transmitters that transmit at a moderate duty cycle, as in, for example only, a time-division duplex (TDD) system such as 802.11 (or “WiFi”), one embodiment includes a single-pole, double-throw RF switch that would suffice to share this same common antenna or directional antenna array between the operating transmitter and the victim-signal detector under the assumption that the victim-signal detector can perform its detection of the victim transmitter with sufficient fidelity during those time periods in which the operating transmitter does not intentionally transmit a radiated signal comprising information for other radios.

In other embodiments such as when the operating transmitter transmits at a high duty cycle (or even at a 100% duty cycle), as in, for example only, an FDD or ZDD system such as described herein, then a three-port circulator could be used to share this same common antenna or directional antenna array between the operating transmitter and the victim-signal detector under the assumption that the victim-signal detector must perform its detection of the victim transmitter with sufficient fidelity during at least some time periods in which the operating transmitter does intentionally transmit a radiated signal comprising information for other radios. Three-port circulators are well known RF devices to those of skill in the art and such devices enable a common port, such as the feed point to an antenna or directional antenna array, to be coupled with low loss to two other ports simultaneously while these two other ports are each substantially isolated (typically 16 to 20 dB of isolation) from each other at the RF pass band of the circulator.

In other embodiments, these same approaches to sharing a same common antenna or directional antenna array between the operating transmitter and the victim-signal detector can also be used instead of or in addition to for carrier sense as a sharing mechanism for other potential users of the same operating band as the operating transmitter. For example, in a TDD system the RF switch could couple the common antenna or directional antenna array feed point either to a victim-signal detector that also has the capability to do in band carrier sense detection or to separate victim-signal and carrier sense detectors at appropriate times.

Similarly, in other embodiments for an FDD or ZDD system (or any other system where the operating transmitter transmits at a very high or 100% duty cycle), the circulator described above could couple, while the operating transmitter transmits, the common antenna or directional antenna array feed point either to a victim-signal detector that also has the capability to do in band carrier sense detection or to separate victim-signal and carrier sense detectors (possibly via an amplifier and signal splitter).

Of course any one or more of these embodiments may be combined in different ways as evident to one skilled in the art in order to enhance the detection of the presence of a victim outside the operating channel of the operational transmitter in order to control the level of OOBE and OOCE.

One or more of the methodologies or functions described herein may be embodied in a computer-readable medium on which is stored one or more sets of instructions (e.g., software). The software may reside, completely or at least partially, within memory and/or within a processor during execution thereof. The software may further be transmitted or received over a network.

The term “computer-readable medium” should be taken to include a single medium or multiple media that store the one or more sets of instructions. The term “computer-readable medium” shall also be taken to include any medium that is capable of storing, encoding or carrying a set of instructions for execution by a machine and that cause a machine to perform any one or more of the methodologies of the present invention. The term “computer-readable medium” shall accordingly be taken to include, but not be limited to, solid-state memories, and optical and magnetic media.

Embodiments of the invention have been described through functional modules at times, which are defined by executable instructions recorded on computer readable media which cause a computer, microprocessors or chipsets to perform method steps when executed. The modules have been segregated by function for the sake of clarity. However, it should be understood that the modules need not correspond to discreet blocks of code and the described functions can be carried out by the execution of various code portions stored on various media and executed at various times.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The invention has been described in relation to particular examples, which are intended in all respects to be illustrative rather than restrictive. Those skilled in the art will appreciate that many different combinations of hardware, software, and firmware will be suitable for practicing the present invention. Various aspects and/or components of the described embodiments may be used singly or in any combination. It is intended that the specification and examples be considered as exemplary only, with a true scope and spirit of the invention being indicated by the claims.

What is claimed is:

1. A radio for exchanging information with one or more other radios comprising:
an operating transmitter configured to transmit an operating channel radio transmission from one or more transmit antennas, each of the one or more transmit antenna responsive to at least an operating frequency band; and
a victim-signal detector configured to detect one or more candidate victim RF signals at one or more detection antennas, each of the one or more detection antennas responsive to at least a victim frequency band;
wherein the victim-signal detector is further configured to indicate at least if a level of detection for one or more candidate victim RF signals exceeds a threshold;
wherein the operating transmitter is further configured to utilize a first set of operational parameters corresponding to a first level of out of band emissions (OOBE) for the operating channel radio transmission if the level of detection for one or more candidate victim RF signals exceeds the threshold;
wherein the operating transmitter is further configured to utilize a second set of operational parameters corresponding to a second level of out of band emissions (OOBE) for the operating channel radio transmission if the level of detection for one or more candidate victim RF signals does not exceed the threshold; and
wherein the first level of out of band emissions (OOBE) is lower than the second level of out of band emissions (OOBE).

2. The radio of claim 1 wherein the victim frequency band does not overlap with the operating frequency band.

3. The radio of claim 1 wherein either of the first level of out of band emissions (OOBE) or the second level of out of band emissions (OOBE) is specified in terms of an average power spectral density.

4. The radio of claim 1 wherein either of the first level of out of band emissions (OOBE) or the second level of out of band emissions (OOBE) is specified in terms of a peak power spectral density.

5. The radio of claim 3 wherein the first level is −41 dBm/MHz.

6. The radio of claim 4 wherein the first level is −27 dBm/MHz.

7. The radio of claim 1 wherein the second level is 20 dB higher than the first level.

8. The radio of claim 1 wherein the threshold is −64 dBm.

9. The radio of claim 1 wherein the operating frequency band comprises at least the U-NII-1 band of 5.15-5.25 GHz and the victim frequency band comprises at least frequency spectrum below 5.15 GHz.

10. The radio of claim 1 wherein at least one of the one or more candidate victim RF signals is assumed to originate from a radar system.

11. The radio of claim 1 wherein at least one of the one or more candidate victim RF signals is assumed to originate from a communications system.

12. The radio of claim 1 wherein the threshold depends upon a type of the one or more candidate victim RF signals.

13. The radio of claim 1 wherein the first set of operational parameters for the operating channel radio transmission comprises one or more of:
a first transmit power level;
a first frequency channel;
a first channel filtering parameter;
a first channel bandwidth;
a first transmit duty cycle; or
combinations thereof.

14. The radio of claim 13 wherein the second set of operational parameters for the operating channel radio transmission comprises one or more of:
a second transmit power level, wherein the second transmit power level is lower than the first transmit power level;
a second frequency channel, wherein the second frequency channel is separated further in the frequency domain from a frequency of at least one of the one or more candidate victim RF signals than the first frequency channel is separated from the frequency of the at least one of the one or more candidate victim RF signals;
a second channel filtering parameter, wherein the second channel filtering parameter causes the operating transmitter to be further configured to have a lower level of out of band emissions (OOBE) than a level of out of band emissions (OOBE) associated with the first channel filtering parameter;
a second channel bandwidth, wherein the second channel bandwidth is smaller than the first channel bandwidth;
a second transmit duty cycle, wherein the second transmit duty cycle is smaller than the first transmit duty cycle; or
combinations thereof.

15. The radio of claim 1 wherein the operating transmitter comprises:
one or more transmit RF chains.

16. The radio of claim 15 wherein at least one transmit RF chain comprises:
a vector modulator and two digital to analog converters.

17. The radio of claim 1 wherein the victim-signal detector comprises:
one or more receive RF chains.

18. The radio of claim 17 wherein at least one receive RF chain comprises:
a vector demodulator and two analog to digital converters.

19. The radio of claim 17 wherein the victim-signal detector comprises one or more of:
a Fast Fourier Transformer (FFT);
a matched filter; or
a received energy level threshold detector.

20. The radio of claim 1 wherein at least one of the one or more transmit antennas is also at least one of the one or more detection antennas.

21. The radio of claim 1 wherein at least one of the one or more transmit antennas or at least one of the one or more detection antennas comprises one or more directional antenna arrays.

22. The radio of claim 21 wherein at least one directional antenna array comprises either a plurality of directional antenna sub-arrays, each directional antenna sub-array comprising a plurality of directional antenna elements, or a plurality of directional antenna elements.

23. The radio of claim 22 wherein at least one directional antenna element is based upon either a patch or dipole antenna element.

24. The radio of claim 20 wherein the at least one of the one or more transmit antennas that is also the at least one of the one or more detection antennas is coupled to or couplable to each of the operating transmitter and the victim-signal detector via at least an RF switch.

25. The radio of claim 24 wherein the RF switch is a single-pole, double-throw RF switch.

26. The radio of claim 20 wherein the at least one of the one or more transmit antennas that is also the at least one of the one or more detection antennas is coupled to or couplable to each of the operating transmitter and the victim-signal detector via at least a circulator.

27. The radio of claim 26 wherein the circulator is a three-port RF device with a first port coupled to or couplable to the operating transmitter, a second port coupled to or couplable to the victim-signal detector, and a third port coupled to or couplable to the at least one of the one or more transmit antennas that is also the at least one of the one or more detection antennas, and wherein an isolation between the first port and the second port is in a range of 16 to 20 dB.

28. The radio of claim 1 wherein the victim-signal detector is further configured to perform carrier sense detection within the operating frequency band.
